(19) United States
(12) Patent Application Publication
(10) Pub. No.: US 2024/0278433 A1
(43) Pub. Date: Aug. 22, 2024

(54) ROBOT SYSTEM, CALIBRATION TOOL, AND CALIBRATION METHOD

(71) Applicant: KABUSHIKI KAISHA YASKAWA DENKI, Fukuoka (JP)

(72) Inventors: Koji NAGAFUCHI, Fukuoka (JP); Hiroki SANEMASA, Fukuoka (JP); Takashi MINAMI, Fukuoka (JP)

(21) Appl. No.: 18/440,146

(22) Filed: Feb. 13, 2024

(30) Foreign Application Priority Data
Feb. 20, 2023 (JP) 2023-024485

(51) Int. Cl. B25J 9/16

(52) U.S. Cl. CPC B25J 9/1692

(57) ABSTRACT

A robot system includes a robot that supports and transfers a substrate W using a hand, a target capable of being placed instead of the substrate, a sensor provided on the hand to detect the target in a non-contact manner while facing the target a first detector that detects a position of the target in the first direction based on a detection result of the sensor facing the target long the first direction and a position of the sensor, and a second detector that controls the robot to move the sensor along a second direction perpendicular to the first direction, and detects a position of the target in the second direction based on a change in the detection result of the sensor due to movement along the second direction and the position of the sensor.

### CROSS-REFERENCE TO RELATED APPLICATIONS

This application is based on and claims priority from Japanese Patent Application No. 2023-024485 filed on Feb. 20, 2023, with the Japan Patent Office, the disclosure of which is incorporated herein in its entirety by reference.

### TECHNICAL FIELD

The present disclosure relates to a robot system, a calibration tool, and a calibration method.

### BACKGROUND

Japanese Patent Laid-open Publication No. 2004-536443 discloses a robot calibration apparatus for calibrating a workpiece handling robot relative to a station. The workpiece handling robot includes a sensor attached to an end effector. The robot calibration apparatus includes a target object. One side of the target object is provided with a pattern including a black area and a white area. The robot calibration apparatus moves the end effector, and the sensor determines the center of the target object based on the switching between the black area and the white area.

### SUMMARY

The present disclosure provides a robot system capable of easily performing calibration.

According to one aspect of the present disclosure, there is provided a robot system including a robot that supports and transfers a substrate using a hand, a target capable of being placed, instead of the substrate, on a substrate support where the substrate is placed before or after transfer by the robot, a sensor provided on the hand to detect the target in a non-contact manner while facing the target, a first detector that controls the robot such that the sensor faces the target along a first direction, and detects a position of the target in the first direction based on a detection result of the sensor facing the target along the first direction and a position of the sensor, and a second detector that controls the robot to move the sensor along a second direction perpendicular to the first direction, and detects a position of the target in the second direction based on a change in the detection result of the sensor due to movement along the second direction and the position of the sensor.

According to another aspect of the present disclosure, there is provided a calibration tool configured to specify a positional relationship between a robot and a substrate accommodation unit based on a detection result of a sensor that is provided on a hand of the robot and detects a target in a non-contact manner while facing the target, the robot supporting a substrate using the hand being introduced into and removed from the substrate accommodation unit along a horizontal first direction, the calibration tool including a target base capable of being introduced into and removed from the substrate accommodation unit along the first direction instead of the substrate, and the target provided on the target base so as to be placed at a position detectable by the sensor from an outside of the substrate accommodation unit in a state where the target base is accommodated in the substrate accommodation unit, in which, when viewed from a perspective facing the target along the first direction, an outline of the target includes a first line and a second line that are non-parallel to each other and each intersects the horizontal direction.

According to yet another aspect of the present disclosure, there is provided a calibration method of specifying a positional relationship between a robot and a substrate support where a substrate is placed before or after transfer by the robot based on a detection result of a sensor provided on a hand of the robot that supports and transfers the substrate using the hand, the calibration method including placing a target on the substrate support, controlling the robot such that the sensor faces the target in a non-contact manner along a first direction, and detecting a position of the target in the first direction based on a detection result of the sensor facing the target in the non-contact manner along the first direction and a position of the sensor, and controlling the robot to move the sensor along a second direction perpendicular to the first direction, and detecting a position of the target in the second direction based on a change in the detection result of the sensor due to movement along the second direction and the position of the sensor.

According to the present disclosure, it is possible to provide a robot system capable of easily performing calibration.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram illustrating a configuration of a robot system.

FIG. 2 is a front view of a calibration tool placed on a substrate support.

FIG. 3 is a cross-sectional view taken along line III-III in FIG. 2.

FIG. 4 is a block diagram illustrating a functional configuration of a robot controller.

FIGS. 5A and 5B are schematic diagrams illustrating the operation of a robot for calibration.

FIG. 6 is a schematic diagram illustrating a relationship between the recognition results of first and second lines and the height of a sensor.

FIG. 7 is a schematic diagram illustrating the operation of the robot by scan control.

FIG. 8 is a front view illustrating a modification of a calibration tool.

FIGS. 9A to 9C are schematic diagrams illustrating the operation of the robot corresponding to the calibration tool in FIG. 8.

FIGS. 10A to 10C are schematic diagrams illustrating the operation of the robot system for performing calibration using a sensing element.

FIG. 11 is a schematic diagram illustrating a modification of the operation of the robot system for performing calibration using a sensing element.

FIG. 12 is a graph illustrating a modification of the operation of the robot system for performing calibration using a sensing element.

FIG. 13 is a block diagram illustrating a hardware configuration of a robot controller.

FIG. 14 is a flowchart illustrating a calibration procedure.

FIG. 15 is a flowchart illustrating a calibration procedure.

FIG. 16 is a flowchart illustrating a mapping procedure.

FIG. 17 is a flowchart illustrating a transfer procedure.

### DETAILED DESCRIPTION

In the following detailed description, reference is made to the accompanying drawing, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments will be described in detail with reference to the drawings. In the description, the same reference numerals will be given to the same elements or elements having the same functions, and redundant descriptions thereof will be omitted.

### [Robot System]

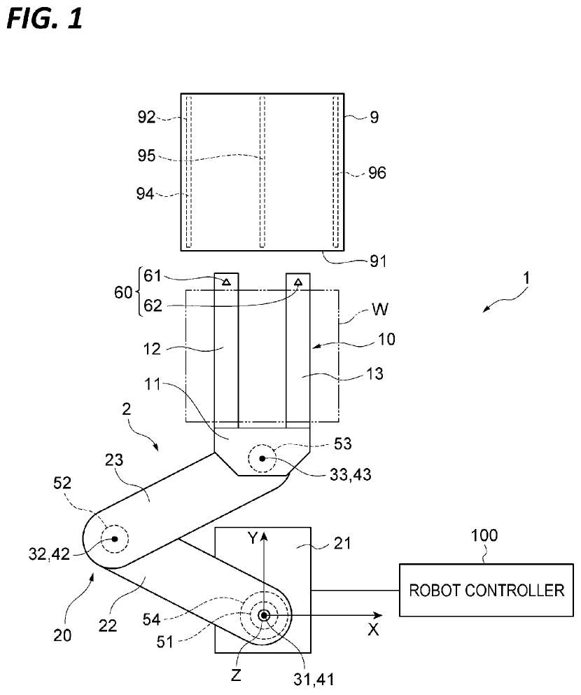

A robot system 1 illustrated in FIG. 1 is a system, for example, for use in a substrate processing apparatus, that supports and transfers a substrate W, which is a processing target, using a hand. An example of the substrate W may include a rectangular panel made of glass or a resin material such as glass epoxy, but is not limited to this. The substrate W may be a semiconductor substrate.

For example, the robot system 1 receives the substrate W from a substrate support to transfer the substrate W, or transfers the substrate W to deliver the substrate W to the substrate support. For example, the substrate support may be provided inside a substrate accommodation unit 9. For example, the substrate accommodation unit 9 is a cassette that accommodates a plurality of substrates W, and includes substrate supports 92 in multiple stages. Each of the multi-stage substrate supports 92 supports the substrate W aligned in the horizontal direction. The interior of the substrate accommodation unit 9 is divided into slots 93 in multiple stages by the multi-stage substrate supports 92.

The substrate accommodation unit 9 further has an opening 91. The opening 91 is open to enable the loading/unloading of the substrate W along a single horizontal direction for each of the multi-stage slots 93. The single horizontal direction is hereinafter referred to as a “depth direction of the substrate accommodation unit 9.” Further, the direction perpendicular to both the vertical direction and the depth direction of the substrate accommodation unit 9 is referred to as a “width direction of the substrate accommodation unit 9.” Each of the multi-stage substrate supports 92 includes a plurality of (e.g., three) rods 94, 95, and 96. The rods 94, 95, and 96 are parallel to each other, and each extends along the horizontal direction (e.g., the depth direction of the substrate accommodation unit 9) at the same height.

The substrate support may be a portion that supports the substrate W to enable the delivery of the substrate W to and from the robot system 1 and is not limited to the substrate support 92 inside the substrate accommodation unit 9. For example, the substrate support may be a portion that supports the substrate W inside a chamber where the substrate W is processed.

The robot system 1 includes a robot 2 and a robot controller 100. The robot 2 supports and transfers the substrate W using a hand. For example, the robot 2 includes a hand 10 and a multi-joint arm 20.

The hand 10 is positioned below the substrate W along the horizontal direction to support the substrate W. For example, the hand 10 has a fork shape when viewed from above, and includes a fork socket 11 and a pair of fork tines 12 and 13. The fork socket 11 is widened along the horizontal direction, and the fork tines 12 and 13 extend from the fork socket 11 in a single horizontal direction so as to be parallel to each other when viewed from above. The substrate W is supported by the fork tines 12 and 13. In addition, the hand 10 is not limited to the above form as long as it is capable of transferring the substrate W by placing it thereon and of loading and unloading the substrate W into and out of the substrate accommodation unit 9.

The multi-joint arm 20 moves the hand 10 to receive the substrate W from the substrate support 92 to transfer the substrate W, or to transfer the substrate W to deliver it to the substrate support 92. For example, in order to receive the substrate W from the substrate support 92 to transfer the substrate W, or to transfer the substrate W to deliver the substrate W to the substrate support 92, the multi-joint arm 20 introduces or removes the hand 10 into or from the substrate accommodation unit 9 through the opening 91. In the following description of the robot 2, the XYZ coordinate system is used in which the direction in which the hand is introduced into the substrate accommodation unit 9 from the opening 91 is taken as the positive Y-axis direction and the vertical upward direction is taken as the positive Z-axis direction. The XYZ coordinate system is assumed to be a robot coordinate system on the basis of the robot 2 (e.g., on the basis of a base 21 to be described later).

The multi-joint arm 20 is configured to change the position of the hand 10 in the Y-direction (first direction), the position of the hand 10 in the X-direction (second direction), and the posture of the hand 10 around the axis along the Z-direction (direction perpendicular to both the first and second directions) through the rotation of one or more joints.

For example, the multi-joint arm 20 includes the base 21, a first arm 22, a second arm 23, and actuators 51, 52, and 53. The base 21 is fixed around the substrate accommodation unit 9. The first arm 22 is connected to the base 21 so as to be rotatable around a vertical axis 31, and extends away from the axis 31. The second arm 23 is connected to an end of the first arm 22 so as to be rotatable around a vertical axis 32, and extends away from the axis 32.

The fork socket 11 of the hand 10 is connected to an end of the second arm 23. For example, the fork socket 11 is connected to the end of the second arm 23 so as to be rotatable around a vertical axis 33. In the above example, the multi-joint arm 20 includes three joints, i.e., a joint 41 interconnecting the base 21 and the first arm 22, a joint 42 interconnecting the first arm 22 and the second arm 23, and a joint 43 interconnecting the second arm 23 and the fork socket 11.

The actuators 51, 52, and 53 drive the joints 41, 42, and 43, respectively. For example, the actuator 51 rotates the first arm 22 around the axis 31, the actuator 52 rotates the second arm 23 around the axis 32, and the actuator 53 rotates the fork socket 11 around the axis 33. The multi-joint arm 20 may further include an actuator 54. The actuator 54 raises or lowers the first arm 22 along the axis 31. The actuators 51, 52, 53, and 54 are, for example, electrically driven, but are not limited to this.

In FIG. 1, each of the actuators 51, 52, 53, and 54 is illustrated at the same position as a driving target, but at least one of the actuators 51, 52, 53, and 54 may be located at a distance from the driving target, thus being connected to the driving target via a power transmission mechanism such as a link, timing belt, or gear.

A configuration of the multi-joint arm 20 may be modified as long as the position of the hand 10 in the first direction, the position of the hand 10 in the second direction, and the posture of the hand 10 around the axis perpendicular to both the first and second directions may be changed. For example, the multi-joint arm 20 may have a greater number of joints. Any two or more of the joints 41, 42, and 43 may be driven by a common actuator via links or others.

The robot 2 further includes a sensor 60. The sensor 60 is provided on the hand 10 to detect the object in a non-contact manner while facing the object. For example, the sensor 60 is a reflective laser sensor that emits laser light in the horizontal direction and detects the reflected light returning from the object. The reflected light returning to the sensor 60 varies depending on whether or not the object is present in the emission direction of laser light, or the distance from the sensor 60 to the object, among others. Therefore, the sensor 60 is capable of detecting the object based on the reflected light.

The sensor 60 may be configured to perform the emission of laser light and the detection of reflected light at a plurality of locations. For example, the sensor 60 includes a first sensing element 61 and a second sensing element 62. The first sensing element 61 is provided at an end of the fork tine 12 and emits laser light in the direction in which the fork tine 12 extends from the fork socket 11 to detect the reflected light. The second sensing element 62 is provided at an end of the fork tine 13 and emits laser light in the direction in which the fork tine 13 extends from the fork socket 11 to detect the reflected light.

The sensor 60 may be configured to output a first signal when the distance to the object is greater than a predetermined distance and to output a second signal when the distance to the object is less than the predetermined distance. When the sensor 60 includes both the first sensing element 61 and the second sensing element 62, each of the first and second sensing elements 61 and 62 may be configured to output the first signal when the distance to the object is greater than the predetermined distance and to output the second signal when the distance to the object is less than the predetermined distance.

The sensor 60 may be used to confirm the presence or absence of the substrate W in a non-contact manner. For example, the ends of the fork tines 12 and 13 may be positioned to face the slot 93 from the outside of the substrate accommodation unit 9, and the sensor 60 may be directed to a position where the substrate W needs to be present to detect the reflected light. Whether or not the substrate W is present in the slot 93 may be confirmed based on the intensity of the reflected light.

The robot controller 100 operates the robot 2 to transfer the substrate W based on a predetermined operation program. The operation program includes, for example, a plurality of operation commands arranged in time-series order. The plurality of operation commands include at least a target position and target posture of the hand 10. The target position and target posture are determined based on a positional relationship between the robot 2 and the substrate support.

There may be a slight discrepancy between an actual positional relationship between the robot 2 and the substrate support and the above positional relationship assumed based on the target position and target posture. Hereinafter, this discrepancy is referred to as “positional relationship discrepancy.” If the positional relationship discrepancy occurs, it becomes challenging to accurately position the hand 10 relative to the substrate support, leading to a decrease in the positioning accuracy of the substrate W after transfer. Therefore, for the accurate transfer of the substrate W, calibration is necessary to reduce the positional relationship discrepancy.

To facilitate calibration, the robot system 1 further includes a target that may be placed, instead of the substrate W, on the substrate support. The robot controller 100 is configured to execute an operation of controlling the robot 2 such that the sensor 60 faces the target along the first direction, and detecting the position of the target in the first direction based on the detection results of the sensor 60 facing the target along the first direction and the position of the sensor 60, and an operation of controlling the robot 2 to move the sensor 60 along the second direction perpendicular to the first direction, and detecting the position of the target in the second direction based on a change in the detection results of the sensor 60 due to the movement along the second direction and the position of the sensor 60.

The single sensor 60 may detect both the position of the target in the first direction and the position of the target in the second direction, and then specify an actual positional relationship between the robot 2 and the substrate support based on the position of the target in the first direction and the position of the target in the second direction. This allows for easy calibration. Hereinafter, the configuration of the target and the robot controller 100 will be described in detail.

### (Target)

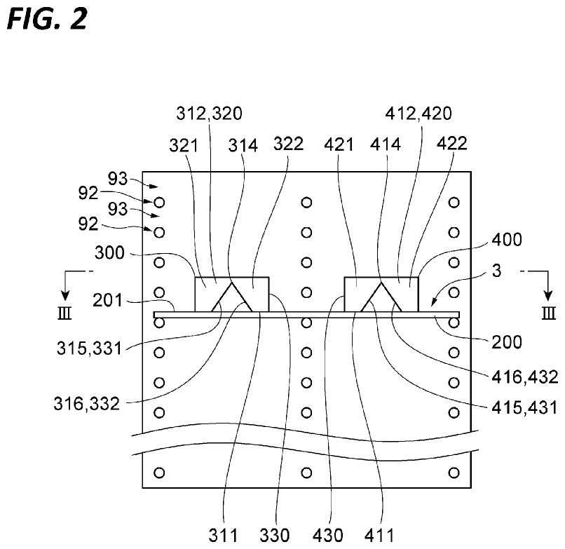

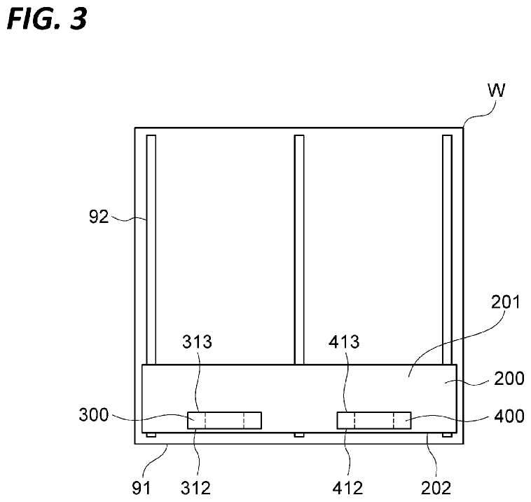

The robot system 1 is provided with a calibration tool 3 including the target. FIG. 2 is a schematic diagram illustrating the calibration tool 3 placed on the substrate support 92 inside the substrate accommodation unit 9. FIG. 3 is a cross-sectional view taken along the line III-III in FIG. 2. As illustrated in FIGS. 2 and 3, the calibration tool 3 includes a target base 200, a first block 300, and a second block 400.

The target base 200 is placed, instead of the substrate W, on the substrate support 92 inside the substrate accommodation unit 9. For example, the target base 200 has a plate shape and is placed on the substrate support 92 along the horizontal direction. The target base 200 is placed on the substrate support 92 according to predetermined placement rules. The placement rules include at least a rule determining on which stage of the substrate support 92 the target base 200 needs to be placed and a rule determining at which position on the substrate support 92 the target base 200 needs to be placed.

The target base 200 has a top surface 201 and a first edge line 202. The top surface 201 faces upward in a state where the target base 200 is placed on the substrate support 92 according to the above placement rules. The first edge line 202 is a straight line that partially constitutes the outline of the target base 200. The first edge line 202 is positioned closest to the opening 91 in a state where the target base 200 is placed on the substrate support 92 according to the above placement rules. The first edge line 202 extends along the width direction of the substrate accommodation unit 9.

The first block 300 and the second block 400 are provided on the top surface 201 so as to be aligned along a line parallel to the first edge line 202. The first block 300 and the second block 400 are positioned near the first edge line 202 on the top surface 201. The first block 300 and the second block 400 are arranged to correspond respectively to the first sensing element 61 and the second sensing element 62 of the sensor 60 described above. For example, the first block 300 and the second block 400 are arranged such that the second sensing element 62 faces the second block 400 when the first sensing element 61 faces the first block 300. For example, the center-to-center distance between the first block 300 and the second block 400 in the direction parallel to the first edge line 202 coincides with the center-to-center distance between the first sensing element 61 and the second sensing element 62.

The first block 300 has a bottom surface 311, a surface 312, and a back surface 313. The bottom surface 311 faces the top surface 201. The surface 312 is perpendicular to the depth direction of the substrate accommodation unit 9 and faces the outside of the opening 91 in a state where the target base 200 is placed on the substrate support 92 according to the above placement rules. The back surface 313 faces the direction opposite to the direction that the surface 312 faces.

Similarly to the first block 300, the second block 400 has a bottom surface 411, a surface 412, and a back surface 413. The bottom surface 411 faces the top surface 201. The surface 412 is perpendicular to the depth direction of the substrate accommodation unit 9 and faces the outside of the opening 91 in a state where the target base 200 is placed on the substrate support 92 according to the above placement rules. The back surface 413 faces the direction opposite to the direction that the surface 412 faces.

In a state where the target base 200 is placed on the substrate support 92 according to the above placement rules, the surfaces 312 and 412 are arranged at positions detectable by the sensor 60 from the outside of the substrate accommodation unit 9. Being detectable by the sensor 60 from the outside of the substrate accommodation unit 9 means that they are detectable without introducing the sensor 60 into the substrate accommodation unit 9. For example, the surfaces 312 and 412 are positioned such that the distance from the opening 91 to the surfaces 312 and 412 is less than the predetermined distance for the sensor 60.

According to the above configuration, the surfaces 312 and 412 become the target detectable by the sensor 60 from the outside of the substrate accommodation unit 9. Hereinafter, a portion of the target constituted by the surface 312 is referred to as a “target 320,” and a portion of the target constituted by the surface 412 is referred to as a “target 420,” to distinguish them from each other.

When viewed from a perspective facing the target 320 along the depth direction of the substrate accommodation unit 9, an outline 330 of the target 320 may have a first line 331 and a second line 332 that are non-parallel to each other and each intersect the width direction of the substrate accommodation unit 9. For example, a V-shaped groove 314 is formed in the bottom surface 311 along the direction perpendicular to the surface 312 and the back surface 313. The groove 314 has a first inner surface 315 and a second inner surface 316, which become closer to each other with an increasing distance from the top surface 201. The formation of the groove 314 in the bottom surface 311 results in the creation of the first line 331 corresponding to the first inner surface 315 and the second line 332 corresponding to the second inner surface 316 in the outline 330.

Further, the formation of the groove 314 in the bottom surface 311 results in dividing the target 320 into a first surface 321 and a second surface 322 aligned along the width direction of the substrate accommodation unit 9. The first line 331 and the second line 332 are positioned between the first surface 321 and the second surface 322.

When viewed from a perspective facing the target 420 along the depth direction of the substrate accommodation unit 9, an outline 430 of the target 420 may have a third line 431 and a fourth line 432 that are non-parallel to each other and each intersect the width direction of the substrate accommodation unit 9. For example, a V-shaped groove 414 is formed in the bottom surface 411 along the direction perpendicular to the surface 412 and the back surface 413. The groove 414 has a third inner surface 415 and a fourth inner surface 416, which become closer to each other with an increasing distance from the top surface 201. The formation of the groove 414 in the bottom surface 411 results in the creation of the third line 431 corresponding to the third inner surface 415 and the fourth line 432 corresponding to the fourth inner surface 416 in the outline 430.

Further, the formation of the groove 414 in the bottom surface 411 results in dividing the target 420 into a third surface 421 and a fourth surface 422 aligned along the width direction of the substrate accommodation unit 9. The third line 431 and the fourth line 432 are positioned between the third surface 421 and the fourth surface 422.

In addition, as long as the above positional relationship discrepancy is slight, the width direction of the substrate accommodation unit 9 approximately coincides with the X-direction in the robot coordinate system, and the depth direction of the substrate accommodation unit 9 approximately coincides with the Y-direction in the robot coordinate system. Therefore, the first line 331 and the second line 332, which intersect the width direction of the substrate accommodation unit 9, intersect the X-direction. Further, the first surface 321 and the second surface 322, which are aligned along the width direction of the substrate accommodation unit 9, are aligned along the X-direction. Similarly, the third line 431 and the fourth line 432, which intersect the width direction of the substrate accommodation unit 9, intersect the X-direction. Further, the third surface 421 and the fourth surface 422, which are aligned along the width direction of the substrate accommodation unit 9, are aligned along the X-direction.

In the above, the outline 330 of the target 320 is defined by the outer shape of the first block 300, and the outline 430 of the target 420 is defined by the outer shape of the second block 400. The outlines 330 and 430 may not be necessarily defined by the outer shape of the blocks. For example, two regions with different reflectivities of laser light may be formed, respectively, on the surfaces 312 and 412, and each of the outlines 330 and 430 may be constituted by the boundary of the two regions. For example, black and white regions may be formed on each of the surfaces 312 and 412, and each of the outlines 330 and 430 may be constituted by the boundary of the black and white regions.

### (Robot Controller)

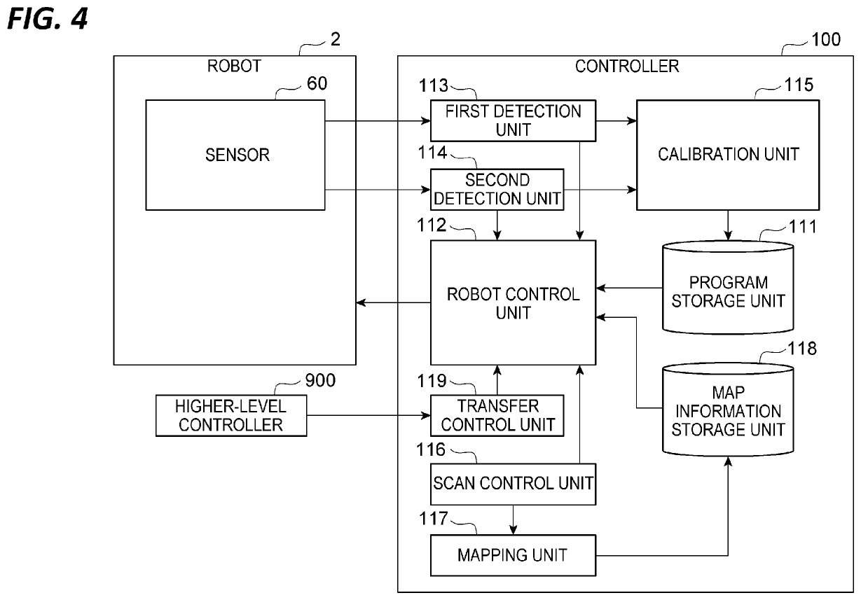

FIG. 4 is a block diagram illustrating a functional configuration of the robot controller 100. As illustrated in FIG. 4, the robot controller 100 includes, as functional components (hereinafter referred to as “function blocks”), a program storage unit 111, a robot control unit 112, a first detection unit 113, a second detection unit 114, and a calibration unit 115. The program storage unit 111 stores the above operation program. In the operation program, the target position and target posture of at least some of the plurality of operation commands may be determined by a coordinate system on the basis of the substrate accommodation unit 9. Hereinafter, the coordinate system on the basis of the substrate accommodation unit 9 is referred to as an “external coordinate system.”

In this case, the operation program further includes coordinate transformation parameters, in addition to the plurality of operation commands. The coordinate transformation parameters are parameters for performing coordinate transformation between the robot coordinate system and the external coordinate system. With such an operation program, the above positional relationship is indicated by the coordinate transformation parameters.

The program storage unit 111 may store a plurality of operation programs corresponding respectively to a plurality of types of operations. Examples of the plurality of operation programs may include a program for operating the robot 2 for the above calibration (hereinafter referred to as a “calibration program”), a program for transferring the substrate W with the robot 2 (hereinafter referred to as a “transfer program”), and a program for operating the robot 2 for mapping to be described later (hereinafter referred to as a “scan program”), among others.

The robot control unit 112 operates the robot 2 based on the operation program stored in the program storage unit 111. When the program storage unit 111 stores the plurality of operation programs, the robot control unit 112 selects the operation program corresponding to a specified operation and operates the robot 2 based on the selected operation program.

As described above, when the target position and target posture are determined by the external coordinate system, the robot control unit 112 transforms the target position and target posture to the target position and target posture in the robot coordinate system based on the coordinate transformation parameters, and then controls the robot 2 to move the hand 10 to the transformed target position and target posture. For example, the robot control unit 112 calculates the operating angles of the actuators 51, 52, and 53 and the lifting height of the first arm 22 by the actuator 54, which are required to move the hand 10 to the target position and target posture, through the use of inverse kinematics computation, and operates the actuators 51, 52, 53, and 54 based on the calculation results.

The first detection unit 113 and the second detection unit 114 detect the position of at least the target 320 for calibration in a state where the target base 200 is placed on the substrate support 92 according to the above placement rules. The first detection unit 113 controls the robot 2 such that the sensor 60 (e.g., the first sensing element 61) faces a portion of the targets 320 and 420 (e.g., the first surface 321 of the target 320) along the first direction (e.g., the Y-direction), and detects the position of the first surface 321 in the first direction based on the detection results of the first sensing element 61 facing the first surface 321 along the first direction and the position of the first sensing element 61. For example, the first detection unit 113 requests the robot control unit 112 to bring the first sensing element 61 to face the first surface 321 along the first direction. The robot control unit 112 controls the robot 2 such that the first sensing element 61 faces the first surface 321 along the first direction based on the calibration program.

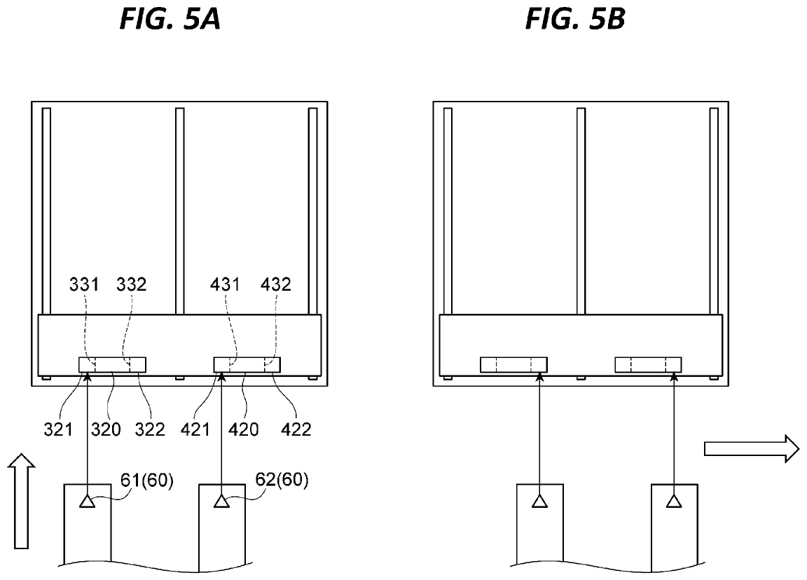

For example, the robot control unit 112 controls the robot 2 to move the first sensing element 61 closer to the first surface 321 along the first direction after the first sensing element 61 faces the first surface 321 at a distance greater than the predetermined distance (see FIG. 5A). The first detection unit 113 detects the position of the first surface 321 in the first direction based on the position of the first sensing element 61 when the output of the first sensing element 61 switches from the first signal to the second signal.

The position of the first sensing element 61 is, for example, the position of the sensor 60 in the robot coordinate system. For example, the first detection unit 113 calculates the position and posture of the hand 10 in the robot coordinate system, and then calculates the Y-coordinate of the first sensing element 61 based on the position and posture of the hand 10 and the position of the first sensing element 61 on the basis of the hand 10, through forward kinematics computation based on the operation results of the actuators 51, 52, 53, and 54. The position of the first sensing element 61 on the basis of the hand 10 is predetermined and stored.

Similarly, the position of the first surface 321 in the first direction is the position of the first surface 321 in the robot coordinate system. When the output of the first sensing element 61 switches from the first signal to the second signal, the distance from the first sensing element 61 to the first surface 321 is substantially equal to the predetermined distance. Therefore, the first detection unit 113 calculates the Y-coordinate of the first surface 321 by adding the predetermined distance to the Y-coordinate of the first sensing element 61 when the output of the first sensing element 61 switches from the first signal to the second signal.

The sensor 60 may be configured to output a signal indicating the distance to the target in a state of facing the target. Each of the first sensing element 61 and the second sensing element 62 may be configured to output a signal indicating the distance to the target in a state of facing the target. In this case, the first detection unit 113 may detect the position of the target 320 in the first direction based on the signal output from the first sensing element 61 facing the target 320 along the first direction and the position of the first sensing element 61. For example, the first detection unit 113 may calculate the Y-coordinate of the target 320 in the first direction by adding the distance based on the signal output from the first sensing element 61 to the Y-coordinate of the first sensing element 61 facing the target 320 along the first direction.

The second detection unit 114 controls the robot 2 to move the sensor 60 (e.g., the first sensing element 61) along the second direction (e.g., the X-direction) perpendicular to the first direction, and detects the position of the target 320 in the second direction based on a change in the detection results of the first sensing element 61 due to the movement along the second direction and the position of the first sensing element 61. The second detection unit 114 may control the robot 2 to move the first sensing element 61 along the second direction after the position of the target 320 in the first direction is detected by the first detection unit 113. After the position of the target 320 in the first direction is detected, the reflected light from the target 320 reliably reaches the sensor 60. Therefore, when the first sensing element 61 moves along the second direction, the difference in the detection results of the first sensing element 61 is more noticeable between a state where the first sensing element 61 faces the first surface 321 and a state where the first sensing element 61 does not face the first surface 321. Therefore, the position of the first surface 321 in the second direction may be detected with higher reliability based on a change in the detection results of the first sensing element 61.

For example, the second detection unit 114 requests the robot control unit 112 to move the first sensing element 61 along the second direction after the position of the first surface 321 in the first direction is detected. The robot control unit 112 controls the robot 2 to move the first sensing element 61 along the second direction based on the calibration program. For example, the robot control unit 112 controls the robot 2 to move the first sensing element 61 from a position where the first sensing element 61 faces the first surface 321 to a position where the first sensing element 61 faces the second surface 322 (see FIG. 5B).

The second detection unit 114 recognizes the outline 330 of the target 320 based on the change in the detection results of the first sensing element 61 due to the movement along the second direction, and detects the position of the target in the second direction based on the position of the sensor 60 when the outline 330 is recognized. For example, the second detection unit 114 recognizes the outline 330 based on the switching of the output of the sensor 60 from the second signal to the first signal or from the first signal to the second signal due to the movement of the sensor 60 along the second direction.

The position of the targets 320 and 420 in the second direction is also the position of the targets 320 and 420 in the robot coordinate system. For example, the second detection unit 114 calculates the position and posture of the hand 10 in the robot coordinate system, and then calculates the X-coordinate of the sensor 60 in the robot coordinate system based on the position and posture of the hand 10 and the position of the sensor 60 on the basis of the hand 10, through forward kinematics computation based on the operation results of the actuators 51, 52, 53, and 54. The second detection unit 114 calculates the X-coordinate of the target 320 based on the X-coordinate of the sensor 60 when the outline 330 is recognized.

The second detection unit 114 may recognize the first line 331 and the second line 332 based on the detection results of the first sensing element 61 moving along the second direction, and detect the position of the target 320 in a third direction (e.g., the Z-direction) perpendicular to both the first and second directions based on the position of the first sensing element 61 when the first line 331 is recognized and the position of the first sensing element 61 when the second line 332 is recognized. It is possible to perform calibration further based on the position of the target 320 in the third direction using the single sensor 60.

The position of the target 320 in the third direction is also the position of the target 320 in the robot coordinate system. For example, the second detection unit 114 calculates the position and posture of the hand 10 in the robot coordinate system, and then calculates the X-coordinate and Z-coordinate of the sensor 60 in the robot coordinate system based on the position and posture of the hand 10 and the position of the sensor 60 on the basis of the hand 10, through forward kinematics computation based on the operation results of the actuators 51, 52, 53, and 54. The second detection unit 114 calculates the Z-coordinate of the target 320 based on the X-coordinate and Z-coordinate of the sensor 60 when the first line 331 is recognized and the X-coordinate and Z-coordinate of the sensor 60 when the second line 332 is recognized.

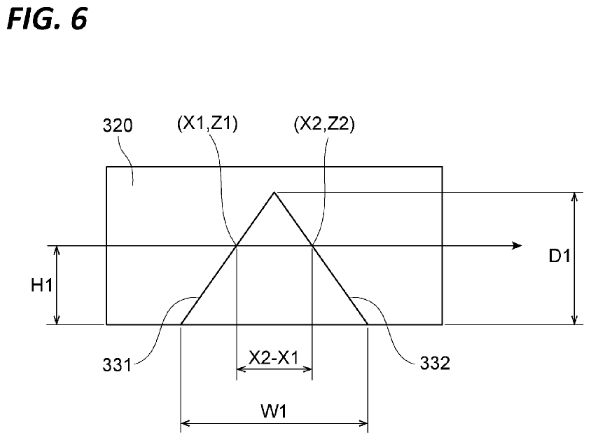

For example, as illustrated in FIG. 6, the second detection unit 114 calculates (X1, Z1) in the drawing as the X-coordinate and Z-coordinate of the sensor 60 when the first line 331 is recognized, and calculates (X2, Z2) in the drawing as the X-coordinate and Z-coordinate of the sensor 60 when the second line 332 is recognized. The second detection unit 114 calculates a height H1 of the sensor from the bottom surface 311 based on the following equation.

H1=D1−D1·|X2−X1/W1
where, D1: Depth of Groove 314, and W1: Opening Width of Groove 314

Thereafter, the second detection unit 114 calculates the Z-coordinate of the bottom surface 311 by subtracting the height H1 from the Z-coordinate of the sensor 60. The Z-coordinate of the sensor 60 may be Z1 or Z2, or the average value of Z1 and Z2.

The second detection unit 114 may calculate the X-coordinate of the target 320 based on the X-coordinate of the sensor 60 when the first line 331 is recognized and the X-coordinate of the sensor 60 when the second line 332 is recognized. For example, the second detection unit 114 calculates the average value of X1 and X2 as the X-coordinate value of the target 320.

The first detection unit 113 and the second detection unit 114 may control the robot 2 to move the first sensing element 61 along the same plane, starting from a state where the first sensing element 61 faces the first surface 321. For example, the robot control unit 112 controls the robot 2 based on a calibration program configured to ensure that a movement path of the first sensing element 61 when becoming closer to the first surface 321 along the first direction in a state of facing the first surface 321 and a movement path of the first sensing element 61 when moving along the second direction are both contained in the same plane. Since there is no movement of the first sensing element 61 in the third direction, it is possible to prevent the vibration of the first sensing element 61 in the third direction. Accordingly, it is possible to detect the position of the target 320 in the third direction with higher reliability.

When the first direction is the Y-direction and the second direction is the X-direction, the first detection unit 113 and the second detection unit 114 move the first sensing element 61 along the horizontal plane, starting from a state where the first sensing element 61 faces the first surface 321. Therefore, it is possible to further prevent the vibration of the first sensing element 61 in the third direction. Accordingly, it is possible to detect the position of the target 320 in the third direction with higher reliability.

The first direction being the Y-direction and the second direction being the X-direction is merely one example, and it may not be strictly necessary for at least one of the first and second directions to be horizontal.

The first detection unit 113 and the second detection unit 114 may control the robot 2 such that a movement path of the first sensing element 61 for detecting the position of the target 320 in the first direction and a movement path of the first sensing element 61 for detecting the position of the target 320 in the second direction are continuous. For example, the robot control unit 112 controls the robot 2 based on a calibration program configured to ensure that a movement path of the first sensing element 61 to a position where the first sensing element 61 faces the first surface 321, a movement path of the first sensing element 61 when becoming closer to the first surface 321 along the first direction in a state of facing the first surface 321, and a movement path of the first sensing element 61 when moving along the second direction are continuous. This allows for easier calibration.

The first detection unit 113 may control the robot 2 to move the first sensing element 61 to a sensing position where the first sensing element 61 becomes closer to the target 320 along the first direction after the output of the first sensing element 61 switches from the first signal to the second signal, and the second detection unit 114 may control the robot 2 to move the first sensing element 61 located at the sensing position along the second direction. This may ensure a more noticeable appearance of the difference in the detection results of the first sensing element 61 between a state where the first sensing element 61 faces the target 320 and a state where the first sensing element 61 does not face the target 320. For example, when the target 320 slightly tilts relative to a plane perpendicular to the first direction, it is conceivable that the first sensing element 61 becomes away from the target 320 with movement in the second direction, causing the output of the first sensing element 61 to switch from the second signal to the first signal. In this case, even though the first sensing element 61 still faces the target 320, the first sensing element 61 may erroneously detect that it does not face the target 320, leading to the misrecognition of the outline 330 of the target 320. The misrecognition of the outline 330 due to the tilt of the target 320 may be prevented by positioning the first sensing element 61 closer to the target 320 before moving the first sensing element 61 along the second direction.

The first detection unit 113 may detect, for each of a first portion and a second portion spaced apart from each other along the second direction, the positions thereof in the first direction, and then detect the tilt of the targets 320 and 420 around an axis (e.g., the Z-axis) perpendicular to the first and second directions based on the detection results for the first and second portions. Calibration may further be performed based on the tilt of the targets. Both the first and second portions may belong to the target 320, or the first portion may belong to the target 320 and the second portion may belong to the target 420.

For example, the first detection unit 113 controls the robot 2 such that the sensor 60 faces each of the first portion and the second portion along the first direction, detects the position (e.g., the Y-coordinate of the robot coordinate system) of the first portion in the first direction based on the detection results of the sensor 60 facing the first portion along the first direction and the position of the sensor 60 facing the first portion along the first direction, detects the position (e.g., the Y-coordinate of the robot coordinate system) of the second portion in the first direction based on the detection results of the sensor 60 facing the second portion along the first direction and the position of the sensor 60 facing the second portion along the first direction, and detects the tilt of the targets 320 and 420 around the axis perpendicular to the first and second directions based on the position of the first portion in the first direction and the position of the second portion in the first direction.

For example, the first detection unit 113 divides the difference between the Y-coordinate of the first portion and the Y-coordinate of the second portion by the gap between the first portion and the second portion, and calculates the arccosine or arctangent of the division result as the tilt angle of the targets 320 and 420.

The first detection unit 113 may perform detection for the first portion by the first sensing element 61 and detection for the second portion by the second sensing element 62. For example, the first detection unit 113 controls the robot 2 such that the first sensing element 61 and the second sensing element 62 face the first portion (e.g., the first surface 321) and the second portion (e.g., the third surface 421), respectively, along the first direction, and detects the position (e.g., the Y-coordinate of the robot coordinate system) of the first surface 321 in the first direction based on the detection results of the first sensing element 61 facing the first surface 321 along the first direction and the position of the first sensing element 61 facing the first surface 321 along the first direction, and detecting the position (e.g., the Y-coordinate of the robot coordinate system) of the third surface 421 in the first direction based on the detection results of the second sensing element 62 facing the third surface 421 along the first direction and the position of the second sensing element 62 facing the third surface 421 along the first direction. The operation of the robot 2 for detecting the first portion and the operation of the robot 2 for detecting the second portion may be performed simultaneously. Thus, it is possible to detect the tilt within a short time. Increasing the gap between the first portion and the second portion improves the accuracy of detecting the tilt of the targets 320 and 420, but when detecting the first portion and the second portion with the sensing elements of the robot system 1, the time for the sensor to move between the first portion and the second portion becomes longer. In contrast, according to a configuration with the first sensing element and the second sensing element, there is no need to move the sensor between the first portion and the second portion. This allows achieving both an improvement in the accuracy of detecting the tilt of the target and a reduction in detection time.

For example, the first detection unit 113 controls the robot 2 to move the first sensing element 61 and the second sensing element 62 closer to the first surface 321 and the third surface 421, respectively, along the first direction after the first sensing element 61 and the second sensing element 62 face the first surface 321 and the third surface 421, respectively, at a distance greater than a predetermined distance, detects the position (e.g., the Y-coordinate of the robot coordinate system) of the first surface 321 in the first direction based on the position of the first sensing element 61 when the output of the first sensing element 61 switches from the first signal to the second signal, and detects the position (e.g., the Y-coordinate of the robot coordinate system) of the third surface 421 in the first direction based on the position of the second sensing element 62 when the output of the second sensing element 62 switches from the first signal to the second signal.

As described above, when both the first sensing element 61 and the second sensing element 62 are used for detection using the first detection unit 113, both the first sensing element 61 and the sensing element 62 may also be used for detection using the second detection unit 114. For example, as described above, in addition to recognizing the first line 331 and the second line 332 based on a change in the detection results of the first sensing element 61 moving along the second direction, the second detection unit 114 recognizes the third line 431 and the fourth line 432 based on a change in the detection results of the second sensing element 62 moving along the second direction, and detects the position of the target 420 in the third direction based on the position of the second sensing element 62 when the third line 431 is recognized and the position of the second sensing element 62 when the fourth line 432 is recognized. A method of detecting the position of the target 420 in the third direction is the same as the above-described method of detecting the position of the target 320 in the third direction based on the position of the first sensing element 61 when the first line 331 is recognized and the position of the second sensing element 62 when the second line 332 is recognized.

By using the first sensing element 61 and the second sensing element 62, it is possible to perform calibration further based on the position of the target 320 in the third direction and the position of the target 420 in the third direction. This allows, for example, enhancing the reliability of the detection results for the position of the targets 320 and 420 in the third direction by using the average value of the position of the target 320 and the position of the target 420 as the detection results. Further, it is possible to perform calibration including the difference between the position of the target 320 in the third direction and the position of the target 420 in the third direction.

The calibration unit 115 calculates the coordinate transformation parameters based on the detection results from the first detection unit 113 and the detection results from the second detection unit 114. For example, the calibration unit 115 calculates the position and posture of the external coordinate system on the basis of the robot coordinate system based on the coordinates of the targets 320 and 420 in the robot coordinate system and the tilt of the targets 320 and 420 around the Z-axis. The calibration unit 115 updates the coordinate transformation parameters stored in the program storage unit 111 using the calculated coordinate transformation parameters. This reduces the positional relationship discrepancy.

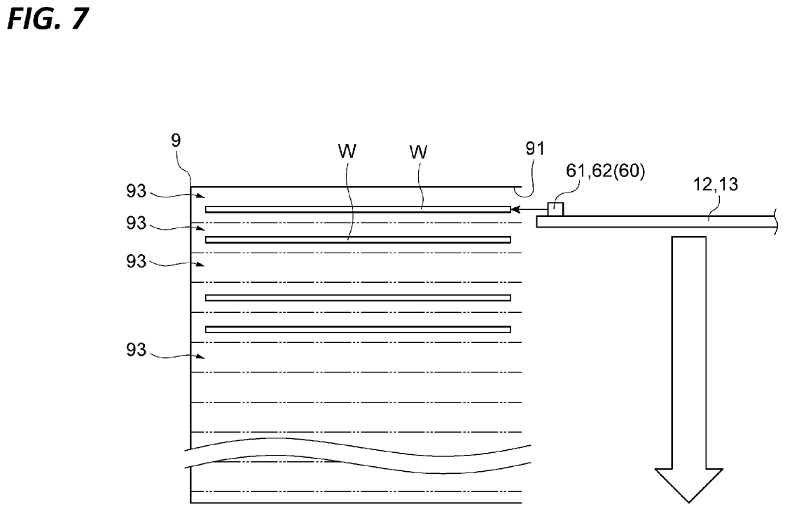

The robot controller 100 may further include a scan control unit 116, a mapping unit 117, and a map information storage unit 118. The scan control unit 116 controls the robot 2 to move the sensor 60 (e.g., at least one of the first sensing element 61 and the second sensing element 62) along the vertical direction such that the sensor 60 faces the substrate accommodation unit 9. For example, the scan control unit 116 requests the robot control unit 112 for scan control to lower the first sensing element 61 and the second sensing element 62 until they face the lowermost slot 93 in the substrate accommodation unit 9 after the first sensing element 61 and the second sensing element 62 face the uppermost slot 93 in the substrate accommodation unit 9 along the Y-direction from the outside of the opening 91. The scan control unit 116 may request the robot control unit 112 to perform scan control to raise the first sensing element 61 and the second sensing element 62 until they face the uppermost slot 93 in the substrate accommodation unit 9 after the first sensing element 61 and the second sensing element 62 face the lowermost slot 93 in the substrate accommodation unit 9 along the Y-direction from the outside of the opening 91. The robot control unit 112 selects the scan program from the plurality of operation programs stored in the program storage unit 111, and executes the scan control based on the selected scan program (see FIG. 7).

The scan control unit 116 requests the robot control unit 112 for the scan control after the coordinate transformation parameters are updated by the calibration unit 115. The robot control unit 112 executes the scan control requested from the scan control unit 116 based on a scan control program including the updated coordinate transformation parameters.

The mapping unit 117 detects whether or not the substrate W is supported on each of the multi-stage substrate supports 92 (whether or not the substrate W is accommodated in each of the multi-stage slots 93) based on the detection results of the first and second sensing elements 61 and 62 moving along the vertical direction through the above scan control, and then stores the detection results in the map information storage unit 118 as map information for the substrate accommodation unit 9. This allows for the updating of the map information stored in the map information storage unit 118. The sensor may also be effectively utilized to detect whether or not the substrate is accommodated in each of the multi-stage slots 93.

The transfer control unit 119 controls the robot 2 to receive the substrate W from the substrate support 92 to transfer the substrate W, or to transfer the substrate W to deliver the substrate W to the substrate support 92, for example, based on instructions from a higher-level controller 900. Hereinafter, the control of the robot 2 to receive the substrate W from the substrate support 92 to transfer the substrate W, or the control of the robot 2 to transfer the substrate W to deliver the substrate W to the substrate support 92 is referred to as “transfer control.” For example, the transfer control unit 119 executes the transfer control by the robot control unit 112. The robot control unit 112 selects the transfer program corresponding to the requested transfer control from the plurality of operation programs stored in the program storage unit 111, and executes the transfer control based on the selected transfer program.

The transfer control unit 119 requests the robot sub controller 112 for the transfer control after the coordinate transformation parameters are updated by the calibration unit 115 and the map information is updated by the mapping unit 117. The robot control unit 112 executes the transfer control requested from the transfer control unit 119 based on the transfer program including the updated coordinate transformation parameters and the updated map information.

### (Modifications of Target)

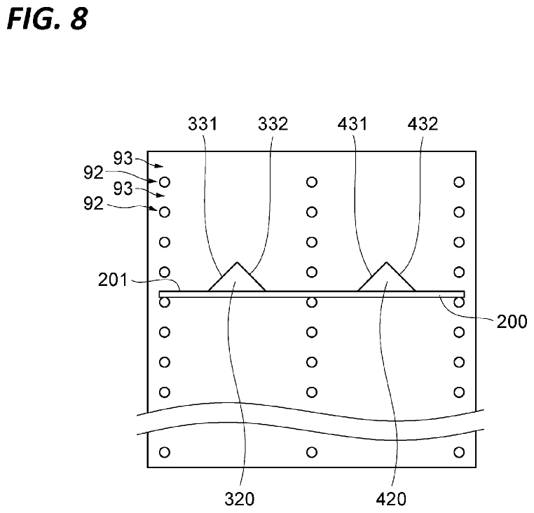

In the above, the targets 320 and 420 have been illustrated such that the first line 331 and the second line 332 are positioned between the first surface 321 and the second surface 322, and the third line 431 and the fourth line 432 are positioned between the third surface 421 and the fourth surface 422, but are not limited to this. As illustrated in FIG. 8, the target 320 may be positioned between the first line 331 and the second line 332, and the target 420 may be positioned between the third line 431 and the fourth line 432.

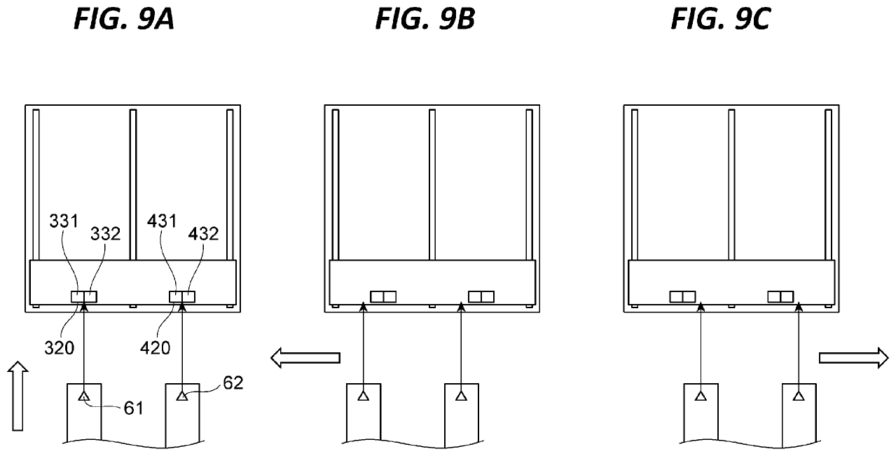

In this case, as illustrated in FIG. 9A, the first detection unit 113 controls the robot 2 to move the first sensing element 61 and the second sensing element 62 closer to the target 320 and the target 420, respectively, along the first direction after the first sensing element 61 and the second sensing element 62 face the target 320 and the target 420, respectively, at a distance greater than a predetermined distance, detects the position (e.g., the Y-coordinate of the robot coordinate system) of the target 320 in the first direction based on the position of the first sensing element 61 when the output of the first sensing element 61 switches from the first signal to the second signal, and detects the position (e.g., the Y-coordinate of the robot coordinate system) of the target 420 in the first direction based on the position of the second sensing element 62 when the output of the second sensing element 62 switches from the first signal to the second signal.

As illustrated in FIG. 9B, the second detection unit 114 controls the robot 2 to move the first sensing element 61 and the second sensing element 62 to one side along the second direction. The second detection unit 114 recognizes the first line 331 when the output signal of the first sensing element 61 switches from the second signal to the first signal, and also recognizes the third line 431 when the output signal of the second sensing element 62 switches from the second signal to the first signal. Thereafter, as illustrated in FIG. 9C, the second detection unit 114 controls the robot 2 to move the first sensing element 61 and the second sensing element 62 to the opposite side along the second direction. The second detection unit 114 recognizes the second line 332 when the output signal of the first sensing element 61 switches from the second signal to the first signal, and also recognizes the fourth line 432 when the output signal of the second sensing element 62 switches from the second signal to the first signal.

The second detection unit 114 detects the X-coordinate and the Z-coordinate of the target 320 based on the X-coordinate and Z-coordinate of the first sensing element 61 when the first line 331 is recognized and the X-coordinate and Z-coordinate of the first sensing element 61 when the second line 332 is recognized. Similarly, the second detection unit 114 detects the X-coordinate and Z-coordinate of the target 420 based on the X-coordinate and Z-coordinate of the second sensing element 62 when the third line 431 is recognized and the X-coordinate and Z-coordinate of the second sensing element 62 when the fourth line 432 is recognized.

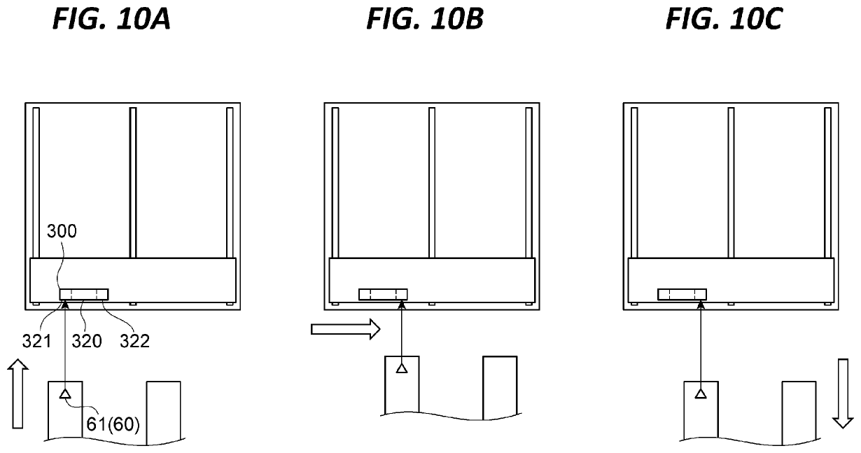

As illustrated in FIGS. 10A to 10C, the calibration tool 3 may not have either the first block 300 or the second block 400. The sensor 60 may not have either the first sensing element 61 or the second sensing element 62. In FIGS. 10A to 10C, the second block 400 and the second sensing element 62 are omitted. In this case, the first detection unit 113 may perform both detection for the first portion and detection for the second portion using the first sensing element 61. In this case, for example, the first surface 321 is used as the first portion and the second surface 322 is used as the second portion.

For example, the first detection unit 113 detects the position (e.g., the Y-coordinate of the robot coordinate system) of the first surface 321 in the first direction based on the detection results of the first sensing element 61 facing the first surface 321 along the first direction, and after moving along the second direction, detects the position of the second surface 322 in the first direction based on the detection results of the first sensing element 61 facing the second portion along the first direction. For example, the first detection unit 113 controls the robot 2 to move the first sensing element 61 closer to the first surface 321 along the first direction after the first sensing element 61 faces the first surface 321 at a distance greater than the predetermined distance (see FIG. 10A), and detects the position of the first surface 321 in the first direction based on the position of the first sensing element 61 when the output of the first sensing element 61 switches from the first signal to the second signal. After stopping the movement of the first sensing element 61 along the second direction in a state where the first sensing element 61 faces the second surface 322 along the first direction (see FIG. 10B), the first detection unit 113 controls the robot 2 such that the first sensing element 61 facing the second portion is spaced apart from the second surface 322 along the first direction (see FIG. 10C), and detects the position of the second surface 322 in the first direction based on the position of the first sensing element 61 when the output of the first sensing element 61 switches from the second signal to the first signal. The movement of the first sensing element 61 along the second direction is executed, for example, by the robot 2 under the control of the second detection unit 114. With the sensing elements of the robot system 1, it is possible to perform calibration further based on the tilt of the target 320.

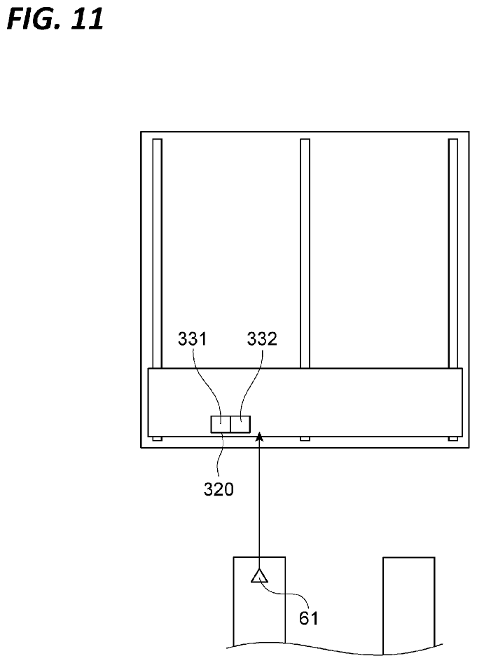

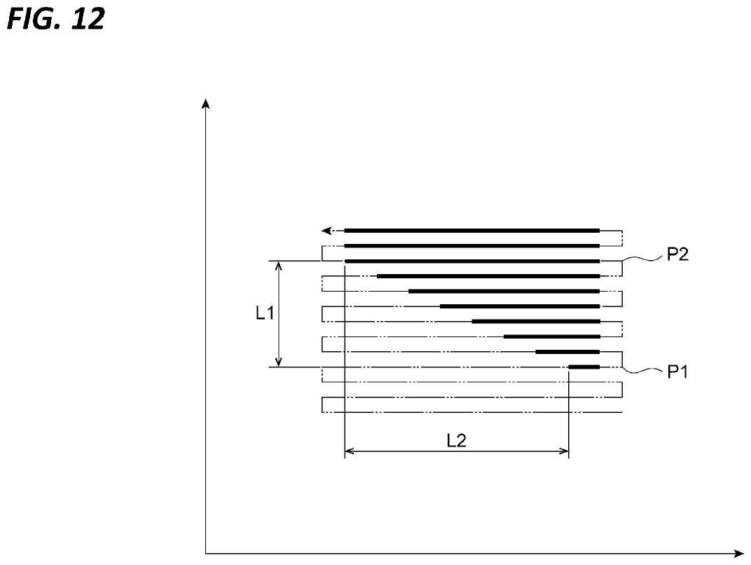

Even when the target 320 is positioned between the first line 331 and the second line 332 and the target 420 is positioned between the third line 431 and the fourth line 432, the calibration tool 3 may not have either the first block 300 or the second block 400, and the sensor 60 may not have either the first sensing element 61 or the second sensing element 62. FIG. 11 illustrates a case where the second block 400 and the second sensing element 62 are omitted and the target 320 is positioned between the first line 331 and the second line 332. In this case, for example, the first detection unit 113 and the second detection unit 114 control the robot 2 such that the first sensing element 61 faces the positive Y-axis direction at a position where it is spaced apart from the target 320 by a distance greater than the predetermined distance and does not face the target 320. Thereafter, the first detection unit 113 and the second detection unit 114 control the robot 2 to reciprocate the first sensing element 61 along the second direction so as to pass the target 320 each time in such a way that the first sensing element 61 becomes closer to the target 32 for each one-way movement. The two-dot dashed line in FIG. 12 indicates the movement trajectory of the first sensing element 61. The vertical axis in FIG. 12 is along the Y-axis, and the horizontal axis in FIG. 12 is along the X-axis.

When moving the first sensing element 61 along the trajectory in FIG. 12 in a state where the target 320 tilts around the Z-axis, the interval during which the first sensing element 61 outputs the second signal becomes longer as the first sensing element 61 becomes closer to the target 320, and then becomes constant. Hereinafter, the interval during which the first sensing element 61 outputs the second signal is referred to as a “second signal interval.” In FIG. 12, the second signal interval is indicated by a solid line. The fact that the second signal interval is constant means that the first sensing element 61 outputs the second signal across the entire region between the first line 331 and the second line 332. For example, the first detection unit 113 recognizes a position P1, which is the Y-coordinate of the first sensing element 61 when the second signal interval first occurs, and a position P2, which is the Y-coordinate of the first sensing element 61 when the second signal interval first becomes constant. The first detection unit 113 detects the tilt of the target 320 around the Z-axis based on an undetected length L2, which is the difference between the length of the second signal interval at the position P2 and the length of the second signal interval at the position P1 and an advance length L1 from the position P1 to the position P2. For example, the first detection unit 113 divides the advance length L1 by the undetected length L2, and calculates the arccosine or arctangent of the division result as the tilt angle of the target 320 around the Z axis.

### (Hardware Configuration)

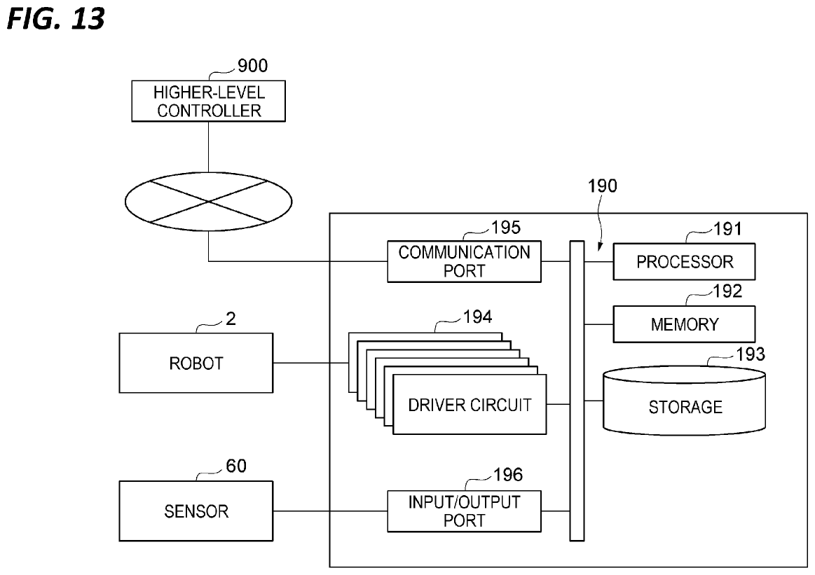

FIG. 13 is a block diagram illustrating a hardware configuration of the robot controller 100. As illustrated in FIG. 13, the robot controller 100 includes a circuit 190. The circuit 190 includes a processor 191, a memory 192, a storage 193, a driver circuit 194, and a communication port 195. The storage 193 is composed of one or more non-volatile memory devices such as a flash memory and a hard disk. The storage 193 stores a program that causes the robot controller 100 to execute a process including controlling the robot 2 such that the sensor 60 faces a target along the first direction, and detecting the position of the target in the first direction based on the detection results of the sensor 60 facing the target along the first direction and the position of the sensor 60, and controlling the robot 2 to move the sensor 60 along the second direction perpendicular to the first direction, and detecting the position of the target in the second direction based on a change in the detection results of the sensor 60 due to the movement along the second direction and the position of the sensor 60. For example, the storage 193 stores a program for configuring the above-described functional blocks in the robot controller 100.

The memory 192 is composed of one or more volatile memory devices such as a random access memory, for example. The memory 192 temporarily stores programs loaded from the storage 193. The processor 191 is composed of one or more computational devices such as a central processing unit (CPU) or graphics processing unit (GPU). The processor 191 configures each of the above-described functional blocks in the second block 400 by executing the programs loaded into the memory 192. The computation results obtained by the processor 191 are temporarily stored in the memory 192.

The driver circuit 194 operates the robot 2 in response to a request from the processor 191. The communication port 195 communicates with the higher-level controller 900 in response to a request from the processor 191. An input/output port 196 performs the input and output of information to and from the sensor 60 in response to a request from the processor 191.

### [Control Procedure]

A control procedure executed by the robot controller 100 is illustrated as an example of a control method. This control procedure includes a calibration procedure, which is an example of a calibration method, a mapping procedure, and a transfer procedure. The mapping procedure is executed after the calibration procedure, and the transfer procedure is executed after both the mapping procedure and the calibration procedure. Hereinafter, each procedure is illustrated.

### (Calibration Procedure)

The calibration procedure includes controlling the robot 2 such that the sensor 60 faces the target 320 along the first direction in a non-contact manner, and detecting the position of the target 320 in the first direction based on the detection results of the sensor 60 facing the target 320 along the first direction in the non-contact manner and the position of the sensor 60, and controlling the robot 2 to move the sensor 60 along the second direction perpendicular to the first direction, and detecting the position of the target 320 in the second direction based on a change in the detection results of the sensor 60 due to the movement along the second direction and the position of the sensor 60.

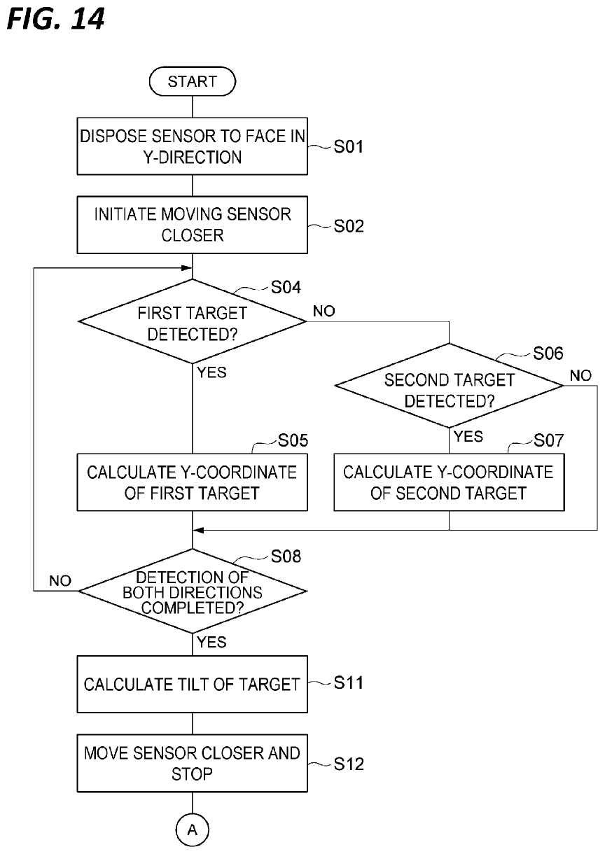

For example, the robot controller 100 executes steps S01 and S02, as illustrated in FIG. 14. In step S01, the first detection unit 113 controls the robot 2 such that the first sensing element 61 and the second sensing element 62 face the first surface 321 and the third surface 421, respectively, at a distance greater than a predetermined distance. In step S02, the first detection unit 113 causes the robot 2 to initiate an operation of moving the first sensing element 61 and the second sensing element 62 closer to the first surface 321 and the third surface 421, respectively, along the first direction.

Next, the robot controller 100 executes step S04. In step S04, the first detection unit 113 confirms whether or not the first surface 321 has been detected by the first sensing element 61. For example, the first detection unit 113 confirms whether or not the output of the first sensing element 61 has switched from the first signal to the second signal.

When it is determined in step S04 that the first surface 321 has been detected by the first sensing element 61, the robot controller 100 executes step S05. In step S05, the first detection unit 113 calculates the position (e.g., the Y-coordinate of the robot coordinate system) of the first surface 321 in the first direction based on the position of the first sensing element 61 when the output of the first sensing element 61 switches from the first signal to the second signal.

When it is determined in step S04 that the first surface 321 has not been detected by the first sensing element 61, the robot controller 100 executes step S06. In step S06, the first detection unit 113 confirms whether or not the third surface 421 has been detected by the second sensing element 62. For example, the first detection unit 113 confirms whether or not the output of the second sensing element 62 has switched from the first signal to the second signal.

When it is determined in step S06 that the third surface 421 has been detected by the second sensing element 62, the robot controller 100 executes step S07. In step S07, the first detection unit 113 detects the position (e.g., the Y-coordinate of the robot coordinate system) of the third surface 421 in the first direction based on the position of the second sensing element nit 62 when the output of the second sensing element 62 switches from the first signal to the second signal.

Next, the robot controller 100 executes step S08. When it is determined in step S06 that the third surface 421 has not been detected by the second sensing element 62, the robot controller 100 executes step S08 without executing step S07. In step S08, the first detection unit 113 confirms whether or not both the detection of the first surface 321 by the first sensing element 61 and the detection of the third surface 421 by the second sensing element 62 have been completed.

When it is determined in step S08 that at least one of the detection of the first surface 321 by the first sensing element 61 and the detection of the third surface 421 by the second sensing element 62 has not been completed, the robot controller 100 returns the process to step S04. When it is determined in step S08 that both the detection of the first surface 321 by the first sensing element 61 and the detection of the third surface 421 by the second sensing element 62 have been completed, the robot controller 100 executes steps S11 and S12.

In step S11, the first detection unit 113 calculates the tilt of the targets 320 and 420 around the Z axis based on the Y-coordinate of the first surface 321 and the Y-coordinate of the third surface 421. In step S12, it controls the robot 2 to move the sensor 60 to a sensing position where the sensor 60 becomes closer to the targets 320 and 420 along the first direction.

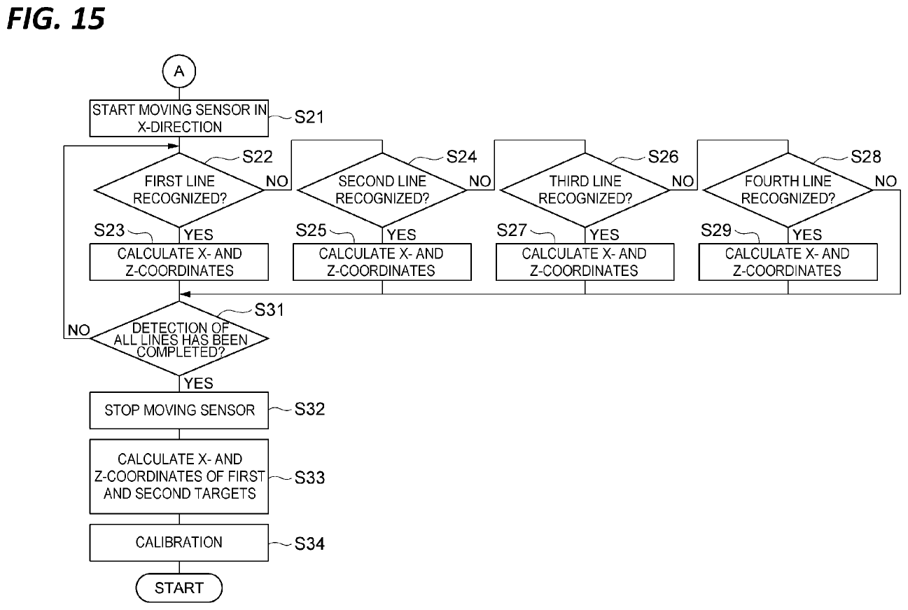

As illustrated in FIG. 15, the robot controller 100 then executes step S21. In step S21, the second detection unit 114 causes the robot 2 to initiate an operation of moving the first sensing element 61 and the second sensing element 62 along the second direction.

Next, the robot controller 100 executes step S22. In step S22, the second detection unit 114 confirms whether or not the first line 331 could be recognized by the first sensing element 61. For example, the second detection unit 114 confirms whether or not the output of the first sensing element 61 has switched from the second signal to the first signal.

When it is determined in step S22 that the first line 331 could be recognized by the first sensing element 61, the robot controller 100 executes step S23. In step S23, the second detection unit 114 calculates the X-coordinate and Z-coordinate of the first sensing element 61 when the first line 331 is recognized.

When it is determined in step S22 that the first line 331 could not be recognized by the first sensing element 61, the robot controller 100 executes step S24. In step S24, the second detection unit 114 confirms whether or not the second line 332 could be recognized by the first sensing element 61. For example, the second detection unit 114 confirms whether or not the output of the first sensing element 61 has switched from the first signal to the second signal.

When it is determined in step S24 that the second line 332 could be recognized by the first sensing element 61, the robot controller 100 executes step S25. In step S25, the second detection unit 114 calculates the X-coordinate and Z-coordinate of the first sensing element 61 when the second line 332 is recognized.

When it is determined in step S24 that the second line 332 could not be recognized by the first sensing element 61, the robot controller 100 executes step S26. In step S26, the second detection unit 114 confirms whether or not the third line 431 could be recognized by the second sensing element 62. For example, the second detection unit 114 confirms whether or not the output of the second sensing element 62 has switched from the second signal to the first signal.

When it is determined in step S26 that the third line 431 could be recognized by the second sensing element 62, the robot controller 100 executes step S27. In step S27, the second detection unit 114 calculates the X-coordinate and Z-coordinate of the second sensing element 62 when the third line 431 is recognized.

When it is determined in step S26 that the third line 431 could not be recognized by the second sensing element 62, the robot controller 100 executes step S28. In step S28, the second detection unit 114 confirms whether or not the fourth line 432 could be recognized by the second sensing element 62. For example, the second detection unit 114 confirms whether or not the output of the second sensing element 62 has switched from the first signal to the second signal.

When it is determined in step S28 that the fourth line 432 could not be recognized by the second sensing element 62, the robot controller 100 executes step S29. In step S29, the second detection unit 114 calculates the X-coordinate and Z-coordinate of the second sensing element 62 when the fourth line 432 is recognized.

Next, the robot controller 100 executes step S31. When it is determined in step S28 that the fourth line 432 could not be recognized by the second sensing element 62, the robot controller 100 executes step S31 without executing step S29. In step S31, the second detection unit 114 confirms whether or not all calculations of the X-coordinate and Z-coordinate of the first sensing element 61 when the first line 331 is recognized, the X-coordinate and Z-coordinate of the first sensing element 61 when the second line 332 is recognized, the X-coordinate and Z-coordinate of the second sensing element 62 when the third line 431 is recognized, and the X-coordinate and Z-coordinate of the second sensing element 62 when the fourth line 432 is recognized have been completed.

When it is determined in step S31 that any one calculation has not been completed, the robot controller 100 returns the process to step S22. When it is determined in step S31 that all of the calculations have been completed, the robot controller 100 executes steps S32, S33 and S34. In step S32, the first detection unit 113 causes the robot 2 to stop the movement of the first and second sensing elements 61 and 62 along the second direction.

In step S33, the second detection unit 114 calculates the X-coordinate and Z-coordinate of the target 320 as described above based on the X-coordinate and Z-coordinate of the first sensing element 61 when the first line 331 is recognized and the X-coordinate and the Z-coordinate of the first sensing element 61 when the second line 332 is recognized. Further, the second detection unit 114 calculates the X-coordinate and Z-coordinate of the target 420 as described above based on the X-coordinate and Z-coordinate of the second sensing element 62 when the third line 431 is recognized and the X-coordinate and Z-coordinate of the second sensing element 62 when the fourth line 432 is recognized.

In step S34, the calibration unit 115 calculates the coordinate transformation parameters based on the detection results from the first detection unit 113 and the detection results from the second detection unit 114. The calibration unit 115 updates the coordinate transformation parameters stored in the program storage unit 111 using the calculated coordinate transformation parameters. With this, the calibration procedure is completed.

### (Mapping Procedure)

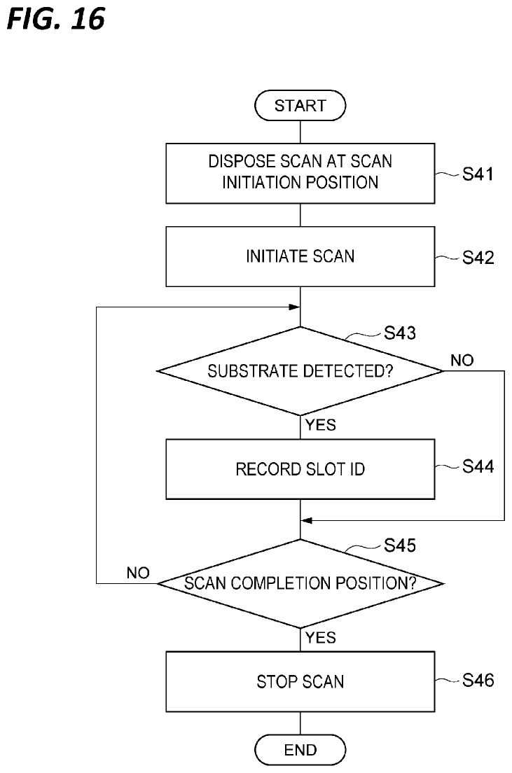

The mapping procedure is a procedure of storing the map information in the map information storage unit 118. As illustrated in FIG. 16, the robot controller 100 executes steps S41, S42 and S43. In step S41, the scan control unit 116 controls the robot 2 such that the first sensing element 61 and the second sensing element 62 face the uppermost slot 93 in the substrate accommodation unit 9 along the Y direction from the outside of the opening 91. In step S42, the scan control unit 116 controls the robot 2 to initiate the lowering of the first sensing element 61 and the second sensing element 62. In step S43, the mapping unit 117 confirms whether or not the substrate W could be detected by the first sensing element 61 and the second sensing element 62. For example, the mapping unit 117 confirms whether or not the outputs of the first sensing element 61 and the second sensing element 62 have switched from the first signal to the second signal.

When it is determined in step S43 that the substrate W could be detected by the first sensing element 61 and the second sensing element 62, the robot controller 100 executes step S44. In step S44, the mapping unit 117 causes the map information storage unit 118 to store identification information of the slot 93 facing the first sensing element 61 and the second sensing element 62 at the point in time when the substrate W could be detected by the first sensing element 61 and the second sensing element 62.

Next, the robot controller 100 executes step S45. When it is determined in step S43 that the substrate W could not be detected by the first sensing element 61 and the second sensing element 62, the robot controller 100 executes step S45 without executing step S44. In step S45, the scan control unit 116 confirms whether or not the first sensing element 61 and the second sensing element 62 have reached a height corresponding to the lowermost slot 93 in the substrate accommodation unit 9. When the scan controller 16 determines in step S45 that the first sensing element 61 and the second sensing element 62 have not reached the height corresponding to the lowermost slot 93, the robot controller 100 returns the process to step S43. When the scan controller 16 determines in step S45 that the first sensing element 61 and the second sensing element 62 have reached the height corresponding to the lowermost slot 93, the robot controller 100 executes step S46. In step S46, the scan control unit 116 causes the robot 2 to stop the lowering of the first sensing element 61 and the second sensing element 62.

With this, the mapping procedure is completed. The scan control unit 116 may allow the first sensing element 61 and the second sensing element 62 to face the lowermost slot 93 in the substrate accommodation unit 9 in step S41, and may raise the first sensing element 61 and the second sensing element 62 in steps S42 to S46.

### (Transfer Procedure)

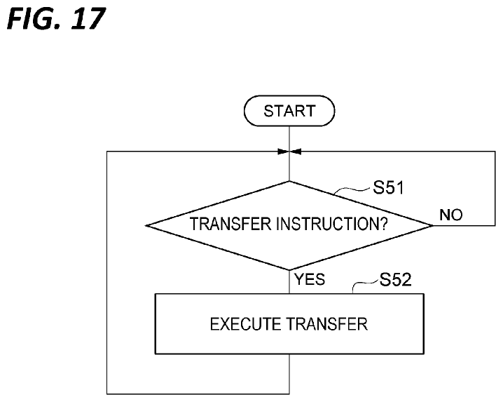

The transfer procedure is a procedure of transferring the substrate W with the robot 2. As illustrated in FIG. 17, the robot controller 100 executes steps S51 and S52. In step S51, the transfer control unit 119 waits for a transfer instruction from the higher-level controller 900. In step S52, the first detection unit 113 causes the robot 2 to execute transfer control in response to the transfer instruction from the higher-level controller 900. The robot controller 100 repeats these steps.

### SUMMARY

The illustrated embodiment includes the following configuration.

(1) A robot system 1 including a robot 2 that supports and transfers a substrate W using a hand 10, a target 320, 420 capable of being placed, instead of the substrate W, on a substrate support 92 where the substrate W is placed before or after transfer by the robot 2, a sensor 60 provided on the hand 10 to detect the target 320, 420 in a non-contact manner while facing the target 320, 420, a first detection unit 113 that controls the robot 2 such that the sensor 60 faces the target 320, 420 along a first direction, and detects a position of the target 320, 420 in the first direction based on a detection result of the sensor 60 facing the target 320, 420 along the first direction and a position of the sensor 60, and a second detection unit 114 that controls the robot 2 to move the sensor 60 along a second direction perpendicular to the first direction, and detects a position of the target 320, 420 in the second direction based on a change in the detection result of the sensor 60 due to movement along the second direction and the position of the sensor 60.

According to the robot system 1, the single sensor 60 may detect both the position of the target 320, 420 in the first direction and the position of the target 320, 420 in the second direction, and then specify a positional relationship between the robot 2 and a transfer destination based on the position of the targets 320 and 420 in the first direction and the position of the targets 320 and 420 in the second direction. Thus, it is possible to easily perform calibration.

(2) The robot system 1 according to configuration (1) as described above, wherein the second detection unit 114 controls the robot 2 to move the sensor 60 along the second direction after the position of the target 320, 420 in the first direction is detected by the first detection unit 113.

When the sensor 60 moves along the second direction, the difference in the detection result of the sensor 60 is more noticeable between a state where the sensor 60 faces the target 320, 420 and a state where the sensor 60 does not face the target 320, 420. Thus, it is possible to detect the position of the target 320, 420 in the second direction with higher reliability.

(3) The robot system 1 according to the configurations (1) or (2), wherein the second detection unit 114 recognizes an outline of the target 320, 420 based on the change in the detection result of the sensor 60 due to the movement along the second direction, and detects the position of the target 320, 420 in the second direction based on a position of the sensor 60 when the outline is recognized.

It is possible to easily detect the position of the target 320, 420 in the second direction.

(4) The robot system 1 according to the configuration (3), wherein, when viewed from a perspective facing the target 320, 420 along the first direction, the outline includes a first line 331 and a second line 332 that are non-parallel to each other and each intersects the second direction, and wherein the second detection unit 114 recognizes the first line 331 and the second line 332 based on the detection result of the sensor 60 moving along the second direction, thus further detecting a position of the target 320, 420 in a third direction perpendicular to both the first and second directions based on a position of the sensor 60 when the first line 331 is recognized and a position of the sensor 60 when the second line 332 is recognized.

It is possible to perform calibration further based on the position of the target 320, 420 in the third direction through the use of the single sensor 60.

(5) The robot system 1 according to the configuration (4), wherein the first detection unit 113 and the second detection unit 114 control the robot 2 to move the sensor 60 along the same plane.

It is possible to prevent the vibration of the sensor 60 in the third direction since there is no movement thereof in the third direction. Thus, it is possible to detect the position of the target 320, 420 in the third direction with higher reliability.

(6) The robot system 1 according to the configuration (5), wherein both the first direction and the second direction are horizontal, and the first detection unit 113 and the second detection unit 114 control the robot 2 to move the sensor 60 along a horizontal plane.

It is possible to further prevent the vibration of the sensor 60 in the third direction. Thus, it is possible to detect the position of the target 320, 420 in the third direction with higher reliability.

(7) The robot system 1 according to the configuration (6), wherein the first detection unit 113 and the second detection unit 114 control the robot 2 such that a movement path of the sensor 60 for detecting the position of the target 320, 420 in the first direction and a movement path of the sensor 60 for detecting the position of the target 320, 420 in the second direction are continuous.

It is possible to more easily perform calibration.

(8) The robot system 1 according to any one of the configurations (4) to (7), wherein the target 320, 420 includes a first surface 321 and a second surface 322 aligned along the second direction and each intersecting the first direction, and wherein the first line 331 and the second line 332 are positioned between the first surface 321 and the second surface 322.

By one-way movement from a position facing the first surface 321 to a position facing the second surface 322, or one-wavy movement from the position facing the second surface 322 to the position facing the first surface 321, the first line 331 and the second line 332 may be recognized by the sensor 60. Thus, it is possible to improve the efficiency of calibration.

(9) The robot system 1 according to any one of the configurations (1) to (8), wherein the robot 2 includes a multi-joint arm 20 connected to the hand 10, and wherein the multi-joint arm 20 is configured to change a position of the hand 10 in the first direction, a position of the hand 10 in the second direction, and a posture of the hand 10 around an axis perpendicular to both the first and second directions, through rotation of one or more joints.

It is possible to effectively utilize the multi-joint arm 20 for calibration.

(10) The robot system 1 according to any one of the configurations (1) to (9), wherein the sensor 60 is configured to output a first signal when a distance to the target 320, 420 is greater than a predetermined distance and to output a second signal when the distance to the target 320, 420 is less than the predetermined distance, and wherein the first detection unit 113 controls the robot 2 to move the sensor 60 closer to the target 320, 420 along the first direction after the sensor 60 faces the target 320, 420 at a distance greater than the predetermined distance, and detects the position of the target 320, 420 in the first direction based on a position of the sensor 60 when an output of the sensor 60 switches from the first signal to the second signal.

(11) The robot system 1 according to the configuration (10), wherein the first detection unit 113 controls the robot 2 to move the sensor 60 to a sensing position closer to the target 320, 420 along the first direction after the output of the sensor 60 switches from the first signal to the second signal, and wherein the second detection unit 114 controls the robot 2 to move the sensor 60 located at the sensing position along the second direction.

This may ensure a more noticeable appearance of the difference in the detection result of the sensor 60 between a state where the sensor 60 faces the target 320, 420 and a state where the sensor 60 does not face the target 320, 420. For example, when the target 320, 420 slightly tilts relative to a plane perpendicular to the first direction, it is conceivable that the sensor 60 becomes away from the target 320, 420 with the movement in the second direction, causing the output of the sensor 60 to switch from the second signal to the first signal. In this case, even though the sensor 60 still faces the target 320, 420, the sensor 60 may erroneously detect that it does not face the target 320, 420, leading to the misrecognition of the outline of the target 320, 420. It is possible to prevent the misrecognition of the outline due to the tilt of the target 320, 420 by positioning the sensor 60 closer to the target 320, 420 before moving the sensor 60 along the second direction.

(12) The robot system 1 according to any one of the configurations (1) to (9), wherein the sensor 60 is configured to output a signal indicating a distance to the target 320, 420 in a state of facing the target 320, 420, and wherein the first detection unit 113 detects the position of the target 320, 420 in the first direction based on the signal output from the sensor 60 facing the target 320, 420 along the first direction and the position of the sensor 60.

It is possible to reduce the operation of the robot 2 required for detecting the position of the target 320, 420 in the first direction.

(13) The robot system 1 according to any one of the configurations (1) to (12), wherein the target 320, 420 includes a first portion and a second portion spaced apart from each other along the second direction, and wherein the first detection unit 113 controls the robot 2 such that the sensor 60 faces each of the first portion and the second portion along the first direction, detects a position of the first portion in the first direction based on a detection result of the sensor 60 facing the first portion along the first direction and a position of the sensor 60 facing the first portion along the first direction, detects a position of the second portion in the first direction based on a detection result of the sensor 60 facing the second portion along the first direction and a position of the sensor 60 facing the second portion along the first direction, and detects a tilt of the target 320, 420 around the axis perpendicular to both the first and second directions based on the position of the first portion in the first direction and the position of the second portion in the first direction.

It is possible to perform calibration further based on the tilt of the target 320, 420.

(14) The robot system 1 according to the configuration (13), wherein the sensor 60 includes a first sensing element 61 and a second sensing element 62 that are spaced apart from each other and detect the target 320, 420, respectively, in a non-contact manner, the second sensing element 62 facing the second portion along the first direction when the first portion faces the first sensing element 61 along the first direction, and wherein the first detection unit 113 controls the robot 2 such that the first sensing element 61 and the second sensing element 62 face the first portion and the second portion, respectively, along the first direction, detects the position of the first portion in the first direction based on a detection result of the first sensing element 61 facing the first portion along the first direction and a position of the first sensing element 61 facing the first portion along the first direction, and detects the position of the second portion in the first direction based on a detection result of the second sensing element 62 facing the second portion along the first direction and a position of the second sensing element 62 facing the second portion along the first direction.

The operation of the robot 2 for detecting the first portion and the operation of the robot 2 for detecting the second portion may be performed simultaneously. Thus, it is possible to detect the tilt within a short time. Increasing the gap between the first portion and the second portion improves the accuracy of detecting the tilt of the target 320, 420, but when detecting the first portion and the second portion with the sensing elements of the robot system 1, the time for the sensor 60 to move between the first portion and the second portion becomes longer. In contrast, according to a configuration with the first sensing element 61 and the second sensing element 62, there is no need to move the sensor 60 between the first portion and the second portion, and therefore, it is possible to achieve both an improvement in the accuracy of detecting the tilt of the target 320, 420 and a reduction in detection time.

(15) The robot system 1 according to the configuration (14), wherein each of the first sensing element 61 and the second sensing element 62 is configured to output a first signal when a distance to the target 320, 420 is greater than a predetermined distance and to output a second signal when the distance to the target 320, 420 is less than the predetermined distance, and wherein the first detection unit 113 controls the robot 2 to move the first sensing element 61 and the second sensing element 62 closer to the first portion and the second portion, respectively, along the first direction after the first sensing element 61 and the second sensing element 62 face the first portion and the second portion, respectively, at a distance greater than the predetermined distance, detects the position of the first portion in the first direction based on a position of the first sensing element 61 when an output of the first sensing element 61 switches from the first signal to the second signal, and detects the position of the second portion in the first direction based on a position of the second sensing element 62 when the output of the second sensing element 62 switches from the first signal to the second signal.

It is possible to effectively utilize the sensor 60, which detects whether the distance to the target 320, 420 is greater or less than the predetermined distance, for the detection of the tilt of the target 320, 420.

(16) The robot system 1 according to the configuration (15), wherein, when viewed from a perspective facing the first portion along the first direction, an outline of the first portion includes the first line 331 and the second line 332 that are non-parallel to each other and each intersects the second direction, and when viewed from a perspective facing the second portion along the first direction, an outline of the second portion includes a third line 431 and a fourth line 432 that are non-parallel to each other and each intersects the second direction, wherein the second detection unit 114 recognizes the first line 331 and the second line 332 based on a change in the detection result of the first sensing element 61 moving along the second direction, detects a position of the first portion in the third direction perpendicular to both the first and second directions based on a position of the first sensing element 61 when the first line 331 is recognized and a position of the first sensing element 61 when the second line 332 is recognized, and recognizes the third line 431 and the fourth line 432 based on a change in the detection result of the second sensing element 62 moving along the second direction, and detects a position of the second portion in the third direction based on a position of the second sensing element 62 when the third line 431 is recognized and a position of the second sensing element 62 when the fourth line 432 is recognized.

It is possible to perform calibration further based on the position of the first portion in the third direction and the position of the second portion in the third direction by using the first sensing element 61 and the second sensing element 62. This allows, for example, enhancing the reliability of the detection result for the position of the target 320, 420 in the third direction by using the average value of the position of the first portion and the position of the second portion as the detection result. Further, it is possible to perform calibration including the difference between the position of the first portion in the third direction and the position of the second portion in the third direction.

(17) The robot system 1 according to the configuration (13), wherein the first detection unit 113 detects the position of the first portion in the first direction based on the detection result of the sensor 60 facing the first portion along the first direction, and after moving along the second direction, detects the position of the second portion in the first direction based on the detection result of the sensor 60 facing the second portion along the first direction.

With the sensing elements of the robot system 1, it is possible to perform calibration further based on the tilt of the target 320, 420.

(18) The robot system 1 according to the configuration (17), wherein the sensor 60 is configured to output the first signal when the distance to the target 320, 420 is greater than the predetermined distance and to output the second signal when the distance to the target 320, 420 is less than the predetermined distance, and wherein the first detection unit 113 controls the robot 2 to move the sensor 60 closer to the target 320, 420 along the first direction after the sensor 60 faces the first portion at a distance greater than the predetermined distance, and detects the position of the first portion in the first direction based on the position of the sensor 60 when the output of the sensor 60 switches from the first signal to the second signal, and after stopping movement of the sensor 60 along the second direction in a state where the sensor 60 faces the second portion along the first direction, controls the robot 2 such that the sensor 60 facing the second portion is spaced apart from the target 320, 420 along the first direction, and detects the position of the second portion in the first direction based on the position of the sensor 60 when the output of the sensor 60 switches from the second signal to the first signal.

(19) The robot system 1 according to any one of the configurations (1) to (18), wherein the substrate support 92 is provided inside a substrate accommodation unit 9 accommodating the substrate W, wherein the robot system 1 further comprises a target base 200 capable of being placed on the substrate support 92 inside the substrate accommodation unit 9 instead of the substrate W, and wherein the target 320, 420 is provided on the target base 200 so as to be placed at a position detectable by the sensor 60 from an outside of the substrate accommodation unit 9 in a state where the target base 200 is supported by the substrate support 92.

It is possible to further improve the efficiency of calibration. Further, it is possible to avoid a situation where the hand 10 collides around the substrate accommodation unit 9 when introducing the sensor 60 into the substrate accommodation unit 9 before calibration.

(20) The robot system 1 according to any one of the configurations (1) to (19), wherein the substrate support 92 is one of multi-stage substrate supports 92 that are provided inside the substrate accommodation unit 9 so as to horizontally support the substrate W, respectively, and wherein the robot system 1 further comprises a scan control unit 116 that controls the robot 2 to move the sensor 60 along a vertical direction while facing the substrate accommodation unit 9, and a mapping unit 117 that detects whether or not the substrate W is supported on each of the multi-stage substrate supports 92 based on a detection result of the sensor 60 moving along the vertical direction.

It is possible to effectively utilize the sensor 60 to detect whether or not the substrate W is accommodated in each of the multi-stage slots.

(21) A calibration tool 3 configured to specify a positional relationship between a robot 2 and a substrate accommodation unit 9 based on a detection result of a sensor 60 that is provided on a hand 10 of the robot 2 and detects a target 320, 420 in a non-contact manner while facing the target 320, 420, the robot 2 supporting a substrate W using the hand 10 being introduced into and removed from the substrate accommodation unit 9 along a horizontal first direction, the calibration tool 3 comprising a target base 200 capable of being introduced into and removed from the substrate accommodation unit 9 along the first direction instead of the substrate W, and the target 320, 420 provided on the target base 200 so as to be placed at a position detectable by the sensor 60 from an outside of the substrate accommodation unit 9 in a state where the target base 200 is accommodated in the substrate accommodation unit 9, wherein, when viewed from a perspective facing the target 320, 420 along the first direction, an outline of the target 320, 420 includes a first line 331 and a second line 332 that are non-parallel to each other and each intersects the horizontal direction.

(22) A calibration method of specifying a positional relationship between a robot 2 and a substrate support 92 where a substrate W is placed before or after transfer by the robot 2 based on a detection result of a sensor 60 provided on a hand 10 of the robot 2 that supports and transfers the substrate W using the hand 10, the calibration method comprising placing a target 320, 420 on the substrate support 92, controlling the robot 2 such that the sensor 60 faces the target 320, 420 in a non-contact manner along a first direction, and detecting a position of the target 320, 420 in the first direction based on a detection result of the sensor 60 facing the target 320, 420 in the non-contact manner along the first direction and a position of the sensor 60, and controlling the robot 2 to move the sensor 60 along a second direction perpendicular to the first direction, and detecting a position of the target 320, 420 in the second direction based on a change in the detection result of the sensor 60 due to movement along the second direction and the position of the sensor 60.

From the foregoing, it will be appreciated that various embodiments of the present disclosure have been described herein for purposes of illustration, and that various Modifications may be made without departing from the scope and spirit of the present disclosure. Accordingly, the various embodiments disclosed herein are not intended to be limiting, with the true scope and spirit being indicated by the following claims.

What is claimed is:

1. A robot system comprising:
a robot configured to support and transfer a substrate using a hand;
a target configured to be placed, instead of the substrate, on a substrate support in which the substrate is placed before or after transfer by the robot;
a sensor provided on the hand and configured to detect the target in a non-contact manner while facing the target;
a first detector configured to control the robot such that the sensor faces the target along a first direction, and detect a position of the target in the first direction based on a detection result of the sensor facing the target along the first direction and a position of the sensor; and
a second detector configured to control the robot to move the sensor along a second direction perpendicular to the first direction, and detect a position of the target in the second direction based on a change in the detection result of the sensor due to movement along the second direction and the position of the sensor.

2. The robot system according to claim 1, wherein the second detector controls the robot to move the sensor along the second direction after the position of the target in the first direction is detected by the first detector.

3. The robot system according to claim 1, wherein the second detector recognizes an outline of the target based on the change in the detection result of the sensor due to the movement along the second direction, and detects the position of the target in the second direction based on a position of the sensor when the outline is recognized.

4. The robot system according to claim 3, wherein, when viewed from a perspective facing the target along the first direction, the outline includes a first line and a second line that are non-parallel to each other and each intersects the second direction, and
the second detector recognizes the first line and the second line based on the detection result of the sensor moving along the second direction, and detects a position of the target in a third direction perpendicular to both the first and second directions based on a position of the sensor when the first line is recognized and a position of the sensor when the second line is recognized.

5. The robot system according to claim 4, wherein the first detector and the second detector control the robot to move the sensor along the same plane.

6. The robot system according to claim 5, wherein
both the first direction and the second direction are horizontal, and
the first detector and the second detector control the robot to move the sensor along a horizontal plane.

7. The robot system according to claim 6, wherein the first detector and the second detector control the robot such that a movement path of the sensor for detecting the position of the target in the first direction and a movement path of the sensor for detecting the position of the target in the second direction are continuous.

8. The robot system according to claim 4, wherein
the target has a first surface and a second surface aligned along the second direction and each intersecting the first direction, and
the first line and the second line are positioned between the first surface and the second surface.

9. The robot system according to claim 1, wherein
the robot includes a multi-joint arm connected to the hand, and
the multi-joint arm is configured to change a position of the hand in the first direction, a position of the hand in the second direction, and a posture of the hand around an axis perpendicular to both the first and second directions, through rotation of one or more joints.

10. The robot system according to claim 1, wherein the sensor is configured to output a first signal when a distance to the target is greater than a predetermined distance and to output a second signal when the distance to the target is less than the predetermined distance, and
the first detector controls the robot to move the sensor closer to the target along the first direction after the sensor faces the target at a distance greater than the predetermined distance, and detects the position of the target in the first direction based on a position of the sensor when an output of the sensor switches from the first signal to the second signal.

11. The robot system according to claim 10, wherein
the first detector controls the robot to move the sensor to a sensing position closer to the target along the first direction after the output of the sensor switches from the first signal to the second signal, and
the second detector controls the robot to move the sensor located at the sensing position along the second direction.

12. The robot system according to claim 1, wherein
the sensor is configured to output a signal indicating a distance to the target in a state of facing the target, and
the first detector detects the position of the target in the first direction based on the signal output from the sensor facing the target along the first direction and the position of the sensor.

13. The robot system according to claim 1, wherein the target includes a first portion and a second portion spaced apart from each other along the second direction, and
the first detector
controls the robot such that the sensor faces each of the first portion and the second portion along the first direction,
detects a position of the first portion in the first direction based on a detection result of the sensor facing the first portion along the first direction and a position of the sensor facing the first portion along the first direction,
detects a position of the second portion in the first direction based on a detection result of the sensor facing the second portion along the first direction and a position of the sensor facing the second portion along the first direction, and
detects a tilt of the target around the axis perpendicular to both the first and second directions based on the position of the first portion in the first direction and the position of the second portion in the first direction.

14. The robot system according to claim 13, wherein the sensor includes a first sensing element and a second sensing element that are spaced apart from each other and detect the target, respectively, in a non-contact manner,
the second sensing element faces the second portion along the first direction when the first portion faces the first sensing element along the first direction, and
the first detector
controls the robot such that the first sensing element and the second sensing element face the first portion and the second portion, respectively, along the first direction,
detects the position of the first portion in the first direction based on a detection result of the first sensing element facing the first portion along the first direction and a position of the first sensing element facing the first portion along the first direction, and
detects the position of the second portion in the first direction based on a detection result of the second sensing element facing the second portion along the first direction and a position of the second sensing element facing the second portion along the first direction.

15. The robot system according to claim 14, wherein each of the first sensing element and the second sensing element is configured to output a first signal when a distance to the target is greater than a predetermined distance and to output a second signal when the distance to the target is less than the predetermined distance, and
the first detector
controls the robot to move the first sensing element and the second sensing element closer to the first portion and the second portion, respectively, along the first direction after the first sensing element and the second sensing element face the first portion and the second portion, respectively, at a distance greater than the predetermined distance,
detects the position of the first portion in the first direction based on a position of the first sensing element when an output of the first sensing element switches from the first signal to the second signal, and
detects the position of the second portion in the first direction based on a position of the second sensing element when the output of the second sensing element switches from the first signal to the second signal.

16. The robot system according to claim 15, wherein, when viewed from a perspective facing the first portion along the first direction, an outline of the first portion includes the first line and the second line that are non-parallel to each other and each intersects the second direction, and
when viewed from a perspective facing the second portion along the first direction, an outline of the second portion includes a third line and a fourth line that are non-parallel to each other and each intersects the second direction,
the second detector
recognizes the first line and the second line based on a change in the detection result of the first sensing element moving along the second direction,
detects a position of the first portion in the third direction perpendicular to both the first and second directions based on a position of the first sensing element when the first line is recognized and a position of the first sensing element when the second line is recognized,
recognizes the third line and the fourth line based on a change in the detection result of the second sensing element moving along the second direction, and
detects a position of the second portion in the third direction based on a position of the second sensing element when the third line is recognized and a position of the second sensing element when the fourth line is recognized.

17. The robot system according to claim 13, wherein the first detector detects the position of the first portion in the first direction based on the detection result of the sensor facing the first portion along the first direction, and after moving along the second direction, detects the position of the second portion in the first direction based on the detection result of the sensor facing the second portion along the first direction.

18. The robot system according to claim 17, wherein the sensor is configured to output the first signal when the distance to the target is greater than the predetermined distance and to output the second signal when the distance to the target is less than the predetermined distance, and
the first detector
controls the robot to move the sensor closer to the target along the first direction after the sensor faces the first portion at a distance greater than the predetermined distance,
detects the position of the first portion in the first direction based on the position of the sensor when the output of the sensor switches from the first signal to the second signal,
stops movement of the sensor along the second direction in a state where the sensor faces the second portion along the first direction,
controls the robot such that the sensor facing the second portion is spaced apart from the target along the first direction, and
detects the position of the second portion in the first direction based on the position of the sensor when the output of the sensor switches from the second signal to the first signal.

19. The robot system according to claim 1, wherein the substrate support is provided inside a cassette accommodating the substrate,
the robot system further comprises a target base capable of being placed on the substrate support inside the cassette instead of the substrate, and
the target is provided on the target base to be placed at a position detectable by the sensor from an outside of the cassette in a state where the target base is supported by the substrate support.

20. The robot system according to claim 1, wherein the substrate support is one of multi-stage substrate supports that are provided inside the cassette and configured to horizontally support the substrate, respectively, and
wherein the robot system further comprises:
a scan controller configured to control the robot to move the sensor along a vertical direction while facing the cassette, and
a mapper configured to detect whether or not the substrate is supported on each of the multi-stage substrate supports based on a detection result of the sensor moving along the vertical direction.

21. A calibration tool configured to specify a positional relationship between a robot and a cassette based on a detection result of a sensor that is provided on a hand of the robot and detects a target in a non-contact manner while facing the target, the robot supporting a substrate using the hand being introduced into and removed from the cassette along a horizontal first direction, the calibration tool comprising:
a target base capable of being introduced into and removed from the cassette along the first direction instead of the substrate, and
the target provided on the target base so as to be placed at a position detectable by the sensor from an outside of the cassette in a state where the target base is accommodated in the cassette,
wherein, when viewed from a perspective facing the target along the first direction, an outline of the target includes a first line and a second line that are non-parallel to each other and each intersects the horizontal direction.

22. A calibration method of specifying a positional relationship between a robot and a substrate support where a substrate is placed before or after transfer by the robot based on a detection result of a sensor provided on a hand of the robot that supports and transfers the substrate using the hand, the calibration method comprising:
placing a target on the substrate support;
controlling the robot such that the sensor faces the target in a non-contact manner along a first direction, and detecting a position of the target in the first direction based on a detection result of the sensor facing the target in the non-contact manner along the first direction and a position of the sensor, and
controlling the robot to move the sensor along a second direction perpendicular to the first direction, and detecting a position of the target in the second direction based on a change in the detection result of the sensor due to movement along the second direction and the position of the sensor.
